(19) United States
(12) Patent Application Publication
(10) Pub. No.: US 2011/0231560 A1
(43) Pub. Date: Sep. 22, 2011

(54) User Equipment (UE) Session Notification in a Collaborative Communication Session

(76) Inventors: Arungundram Chandrasekaran Mahendran, San Diego, CA (US); Haipeng Jin, Carlsbad, CA (US); Roozbeh Atarius, San Diego, CA (US)

(21) Appl. No.: 12/878,763

(22) Filed: Sep. 9, 2010

Related U.S. Application Data
(60) Provisional application No. 61/241,809, filed on Sep. 11, 2009.
(60) Provisional application No. 61/286,280, filed on Dec. 14, 2009.

(51) Int. Cl. G06F 15/16

(52) U.S. Cl. 709/228

(57) ABSTRACT

A communication system facilitates notification of a controller User Equipment (UE) about the changes of session description in a collaborative session by subscribing to a Session Continuity Controller (SCC) Application Server (AS). First, controller UE subscribes to its dialog event package with the SCC AS. Second, SCC AS maintains several dialogs with controller UE, controllee UE(s) and remote UEs within the collaborative session. Third, when there is an updates in the session description of UEs in the collaborative session, SCC AS notifies the controller UE about the change in a SIP NOTIFY request that is constructed by having an XML body with a session description element containing the Session Description Protocol (SDP) of all of the controllee UEs and remote UEs, including media lines and related information such as as the IP addresses of the UEs.

### CLAIM OF PRIORITY UNDER 35 U.S.C. §119

The present Application for Patent claims priority to Provisional Application No. 61/241,809 entitled “Monitor Media Sessions in a Collaborative Session” filed Sep. 11, 2009, and assigned to the assignee hereof and hereby expressly incorporated by reference herein.

The present Application for Patent claims priority to Provisional Application No. 61/286,280 entitled “User Equipment (UE) Session Notification in a Collaborative Communication Session” filed Dec. 14, 2009, and assigned to the assignee hereof and hereby expressly incorporated by reference herein.

### BACKGROUND

1. Field

The present disclosure relates generally to communication, and more specifically to techniques for orderly coordination of user equipment in a collaborative communication session in a wireless communication network.

2. Background

A user may operate more than one communication device in a communication session. For instance, in a multi-media communication session with different communication components including voice and video, the user may use different devices for voice and video streams. Further, the same user may add, remove and exchange the communication components among the different communication devices. All such changes require orderly coordination and collaboration among the different devices. A communication session as aforementioned is hereinafter called a collaborative communication session, or merely a collaborative session.

For a more specific example, the user may initially use a mobile telephone for both voice and video communications with another user in a teleconference call. Later, when a better video display device is available, for example, a high definition television (HDTV), the user may decide to transfer the video component of the teleconference call to the HDTV but maintain the voice communication over the mobile telephone. Still later, the user may decide to exchange instant messages (IMs) with the other user via yet another communication device, for example, a laptop computer. Even though the user is using multiple devices in this collaborative session, the mobile telephone may remain as the controlling device which the user may use to manage all the media components.

### SUMMARY

The following presents a simplified summary in order to provide a basic understanding of some aspects of the disclosed aspects. This summary is not an extensive overview and is intended to neither identify key or critical elements nor delineate the scope of such aspects. Its purpose is to present some concepts of the described features in a simplified form as a prelude to the more detailed description that is presented later.

In one aspect, a method is provided for Internet Protocol Multimedia Subsystem (IMS) service continuity in a home network based collaborative session. A Session Continuity Controller (SCC) Application Server (AS) receives from a selected one of a controller User Equipment (UE) and a controllee UE a subscription to a dialog event package for a collaborative session that terminates at a remote UE. SCC AS detects a change in Inter-UE Transfer (IUT) of media content for the collaborative session. SCC AS determines that the selected one of the controller UE and the controllee UE did not signal for the change in IUT of the media content. SCC AS notifies the selected one of the controller UE and the controllee UE of the change in IUT of the media content.

In another aspect, at least one processor is provided for IMS service continuity in a home network based collaborative session. A first module receives from a selected one of a controller UE and a controllee UE a subscription to a dialog event package for a collaborative session that terminates at a remote UE. A second module detects a change in IUT of media content for the collaborative session. A third module determines that the selected one of the controller UE and the controllee UE did not signal for the change in IUT of the media content. A fourth module notifies the selected one of the controller UE and the controllee UE of the change in IUT of the media content.

In an additional aspect, a computer program product is provided for IMS service continuity in a home network based collaborative session. A non-transitory computer-readable medium stores sets of code. A first set of codes causes a computer to receive from a selected one of a controller UE and a controllee UE a subscription to a dialog event package for a collaborative session that terminates at a remote UE. A second set of codes causes the computer to detect a change in IUT of media content for the collaborative session. A third set of codes causes the computer to determine that the selected one of the controller UE and the controllee UE did not signal for the change in IUT of the media content. A fourth set of codes causes the computer to notify the selected one of the controller UE and the controllee UE of the change in IUT of the media content.

In a further aspect, an apparatus is provided for IMS service continuity in a home network based collaborative session. The apparatus comprises means for receiving from a selected one of a controller UE and a controllee UE a subscription to a dialog event package for a collaborative session that terminates at a remote UE. The apparatus comprises means for detecting a change in IUT of media content for the collaborative session. The apparatus comprises means for determining that the selected one of the controller UE and the controllee UE did not signal for the change in IUT of the media content. The apparatus comprises means for notifying the selected one of the controller UE and the controllee UE of the change in IUT of the media content.

In yet another aspect, an apparatus is provided for IMS service continuity in a home network based collaborative session. A network interface receives from a selected one of a controller UE and a controllee UE a subscription to a dialog event package for a collaborative session that terminates at a remote UE. A computing platform detects a change in IUT of media content for the collaborative session and for determining that the selected one of the controller UE and the controllee UE did not signal for the change in IUT of the media content. The network interface further notifies the selected one of the controller UE and the controllee UE of the change in IUT of the media content.

In yet an additional aspect, a method is provided for IMS service continuity in a home network based collaborative session. A selected one of a controller UE and a controllee UE signals a SCC AS for participating in a collaborative session terminating at a remote UE. The selected one of a controller UE and a controllee UE transmits to the SCC AS a subscription to a dialog event package for the collaborative session. The selected one of a controller UE and a controllee UE receives a notification from the SCC AS responsive to the subscription of a change in IUT of media content, wherein the SCC AS detected the change in IUT of the media content for the collaborative session and further determined that the selected one of the controller UE and the controllee UE did not signal for the change in IUT of the media content.

In yet a further aspect, at least one processor is provided for IMS service continuity in a home network based collaborative session. A first module signals a SCC AS for participating in a collaborative session terminating at a remote UE as a selected one of a controller UE and a controllee UE. A second module transmits to the SCC AS a subscription to a dialog event package for the collaborative session. A third module receives a notification from the SCC AS responsive to the subscription of a change in IUT of media content, wherein the SCC AS detected the change in IUT of the media content for the collaborative session and further determined that the selected one of the controller UE and the controllee UE did not signal for the change in IUT of the media content.

In another aspect, a computer program product is provided for IMS service continuity in a home network based collaborative session. A non-transitory computer-readable medium stores sets of code. A first set of codes causes a computer to signal a SCC AS for participating in a collaborative session terminating at a remote UE as a selected one of a controller UE and a controllee UE. A second set of codes causes the computer to transmit to the SCC AS a subscription to a dialog event package for the collaborative session. A third set of codes causes the computer to receive a notification from the SCC AS responsive to the subscription of a change in IUT of media content, wherein the SCC AS detected the change in IUT of the media content for the collaborative session and further determined that the selected one of the controller UE and the controllee UE did not signal for the change in IUT of the media content.

In an additional aspect, an apparatus is provided for IMS service continuity in a home network based collaborative session. The apparatus comprises means for signaling a SCC AS for participating in a collaborative session terminating at a remote UE as a selected one of a controller UE and a controllee UE. The apparatus comprises means for transmitting to the SCC AS a subscription to a dialog event package for the collaborative session. The apparatus comprises means for receiving a notification from the SCC AS responsive to the subscription of a change in IUT of media content, wherein the SCC AS detected the change in IUT of the media content for the collaborative session and further determined that the selected one of the controller UE and the controllee UE did not signal for the change in IUT of the media content.

In yet another aspect, an apparatus is provided for IMS service continuity in a home network based collaborative session. A transceiver of a selected one of controller UE and a controllee UE signals a SCC AS for participating in a collaborative session terminating at a remote UE. A computing platform via the transceiver transmits to the SCC AS a subscription to a dialog event package for the collaborative session. The transceiver further receives a notification from the SCC AS responsive to the subscription of a change in IUT of media content, wherein the SCC AS detected the change in IUT of the media content for the collaborative session and further determined that the selected one of the controller UE and the controllee UE did not signal for the change in IUT of the media content.

To the accomplishment of the foregoing and related ends, one or more aspects comprise the features hereinafter fully described and particularly pointed out in the claims. The following description and the annexed drawings set forth in detail certain illustrative aspects and are indicative of but a few of the various ways in which the principles of the aspects may be employed. Other advantages and novel features will become apparent from the following detailed description when considered in conjunction with the drawings and the disclosed aspects are intended to include all such aspects and their equivalents.

### BRIEF DESCRIPTION OF THE DRAWINGS

The features, nature, and advantages of the present disclosure will become more apparent from the detailed description set forth below when taken in conjunction with the drawings in which like reference characters identify correspondingly throughout and wherein:

FIG. 1 illustrates a high-level schematic diagram of a communication system that supports a collaborative session across multiple access networks.

FIG. 2 illustrates a schematic diagram of a communication system employing three different Radio Access Technologies (RATs).

FIG. 3 illustrates an exemplary call flow for signaling and exchanges of session components between various entities such as for controller User Equipment (UE) initiated media transfer from controllee UE to another controllee UE.

FIG. 4 illustrates an exemplary hardware operating environment for a UE or network entity such as a Session Continuity Controller (SCC) Application Server (AS).

FIG. 5 illustrates an exemplary call flow for monitoring media sessions in a collaborative session.

FIG. 6 illustrates a flow diagram for a methodology performed by a network entity such as an SCC AS for Internet Protocol Multimedia Subsystem (IMS) continuity in a home network based collaborative session.

FIG. 7 illustrates a flow diagram for a methodology performed by a UE for IMS continuity in a home network based collaborative session.

FIG. 8 illustrates a block diagram of a logical grouping of electrical components of a network entity such as an SCC AS for IMS continuity in a home network based collaborative session.

FIG. 9 illustrates a block diagram of a logical grouping of electrical components of a UE for IMS continuity in a home network based collaborative session.

FIG. 10 depicts a block diagram of an apparatus of a network entity such as an SCC AS having means for IMS continuity in a home network based collaborative session.

FIG. 11 depicts a block diagram of an apparatus of a UE having means for IMS continuity in a home network based collaborative session.

FIG. 12 depicts a call flow diagram of a controller UE initiated media transfer from controllee UE to another controllee UE.

### DETAILED DESCRIPTION

The following description is presented to enable any person skilled in the art to make and use the innovation. Details are set forth in the following description for purpose of explanation. It should be appreciated that one of ordinary skill in the art would realize that the innovation may be practiced without the use of these specific details. In other instances, well known structures and processes are not elaborated in order not to obscure the description of the invention with unnecessary details. Thus, the present invention is not intended to be limited by the examples shown, but is to be accorded with the widest scope consistent with the principles and features disclosed herein.

Furthermore, in the following description, for reasons of conciseness and clarity, terminology associated with the Wideband Code Division Multiple Access (WCDMA) and the Long Term Evolution (LTE) standards, as promulgated under the 3^{rd} Generation Partnership Project (3GPP) by the International Telecommunication Union (ITU) is used. It should be emphasized that the invention is also applicable to other technologies, such as technologies and the associated standards related to Code Division Multiple Access (CDMA), Time Division Multiple Access (TDMA), Frequency Division Multiple Access (FDMA), Orthogonal Frequency Division Multiple Access (OFDMA) and so forth. Terminologies associated with different technologies can vary. For example, depending on the technology considered, a User Equipment (UE) used in the WCDMA standards can sometimes be called an Access Terminal (AT), a user terminal, a Mobile Station (MS), a subscriber unit, a User Equipment (UE), a mobile device, a system, a subscriber unit, a subscriber station, mobile, cellular device, multi-mode device, remote station, remote terminal, user agent, a user device, or the like. A subscriber station can be a cellular telephone, a cordless telephone, a Session Initiation Protocol (SIP) phone, a wireless local loop (WLL) station, a personal digital assistant (PDA), a handheld device having wireless connection capability, or other processing device connected to a wireless modem or similar mechanism facilitating wireless communication with a processing device. etc., to name just a few. Likewise, an Access Network (AN) used in the WCDMA standards can sometimes be called an access point, an Access Node (AN), a Node B, a Base Station (BS) and so forth. It should here be noted that different terminologies apply to different technologies when applicable.

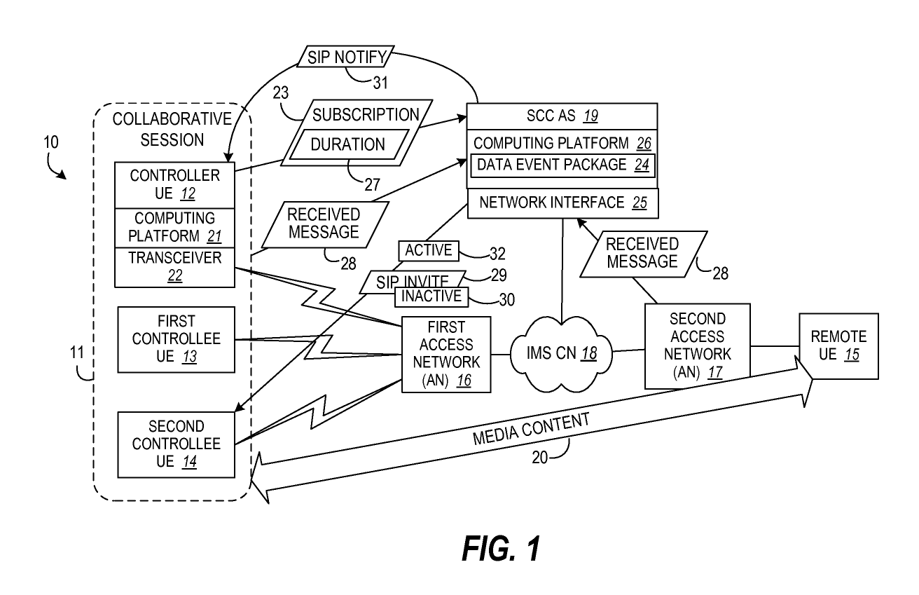

With initial reference to FIG. 1, a communication system 10 facilitates a collaborative session 11 depicted as between controller User Equipment (UE) 12, first controllee UE 13, and second controllee UE 14 that transfer media with a remote UE 15. UEs 12-14 are serviced by a first Access Network (AN) 16 and the remote UE 15 is serviced by a second AN 17. The two ANs 16, 17 communicate packet data via an IMS CN 18. In particular, the communication system 10 facilitates Inter-UE Transfers (IUT) by notifying the controller UE 12 about the changes in media transfer 20 between controllee UEs 13, 14 and the remote UE 15. In particular, the controller UE 12 can be made aware of changes of a session description in the collaborative session 11 by subscribing to a network apparatus depicted as a Session Continuity Controller (SCC) Application Server (AS) 19.

IP Multimedia Subsystem (IMS) service continuity is a home network based IMS application which provides IUT of one or more components of IMS multimedia sessions across different ANs 16, 17. In addition, service continuity enables adding, deleting, and transferring media flows of IMS multi-media sessions or transferring whole IMS multi-media sessions across multiple UEs 12-14 belonging to the same IMS subscription. IUT for service continuity allows a multimedia session to be split on the local end across two or more UEs 12-14 that are part of the collaborative session 11.

In one aspect when a collaborative session is established using a REFER method, it is essential for the controller UE to know the status of the media flow(s) and the session(s) in the controllee UEs. One of ordinary skill in the art can be aware of 3GPP TS 23.237 version 9.1.0, for instance, that describes collaborative sessions in general. The status of the collaborative session can be monitored by subscribing to the dialog event package of the controllee UEs in the collaborative session. However, there is no conventional mechanism for the controller UE to monitor the media status (such as removal of a flow on the controllee UE by the controllee UE itself or the remote end). Disclosed examples provide a mechanism to solve the monitoring of status of the media flow(s) after the establishment of the collaborative session.

In some examples, NOTIFY is used to monitor the status of the media flow(s)/session(s) after the establishment of the collaborative session. When a collaborative session is established using the REFER, an implicit subscription is created. Typically, after the establishment of the collaborative session, this implicit subscription is torn down by the SCC AS by setting the subscription-state to “terminated” in the NOTIFY header. In one aspect, the present innovation discloses a mechanism whereby the implicit subscription is not terminated after establishment of the collaborative session, but is maintained over the entire life of the collaborative session. Thereby, this implicit subscription can now be used for notifying the controller UE when media flow changes (such as removal of media) on the controllee UEs, or when the controllee UE(s) terminates the access leg. The innovation also discloses including the SDP body in the NOTIFY request to indicate the media status on the controllee UEs. Other options for indicating the media status can be to use an XML body, along with sipfrag body, to indicate the status.

In another aspect, with continued reference to FIG. 1, first, controller UE 12 uses a computing platform 21 via a transceiver 22 to subscribe, as depicted at 23, to its dialog event package 24 with the SCC AS 19. The SCC 19 includes a network interface 25 for communicating with the ANs 16, 17 via the IMS CN 18 and a computing platform 26 for processing the dialog event package 24. The subscription 23 can have a duration 27 specified that is sufficient for the expected use of the collaborative session 11 rather than an implicit termination after session establishment. Second, SCC AS 19 maintains several dialogs with the controller UE 12, controllee UE(s) 13, 14 and remote UEs 15 within the collaborative session 11. SCC AS 19 can detect a media transfer 20 between controllee UEs 13-14. For instance, a received message 28 can contain a Refer-to Header addressed to the second controllee UE 14 and the Uniform Resource Identifier (URI) parameters, listing a media line which is not currently supported by the first controllee UE 13 but rather by the second controllee UE 14. Thereby, the SCC AS 19 realizes that the procedure is for transferring the media from the first controllee UE 13 to the second controllee UE 14. SCC AS 19 sends a SIP INVITE request 29 to the second controllee UE 14 to transfer the media component. The Session Description Protocol (SDP) in the INVITE lists are the media lines within the collaborative session 11. In order to avoid the second controllee UE 14 starting to send media to the remote UE 15, the SCC-AS 19 adds a line to be inactive in the SDP offer as depicted at 30. Thus, when there are updates in the session description of UEs 12-14 in the collaborative session 11, SCC AS 19 notifies the controller UE 12 about the change in a SIP NOTIFY request 31 that is constructed by having an XML body with a session description element containing the SDP of all of the controllee UEs 13-14 and remote UEs 15, including media lines and related information such as the IP addresses of the UEs 12-15. With coordination complete among participants in the collaborative session 11, the SCC AS 19 signals the second controllee UE 13 as depicted at 32 to be active to transfer the media.

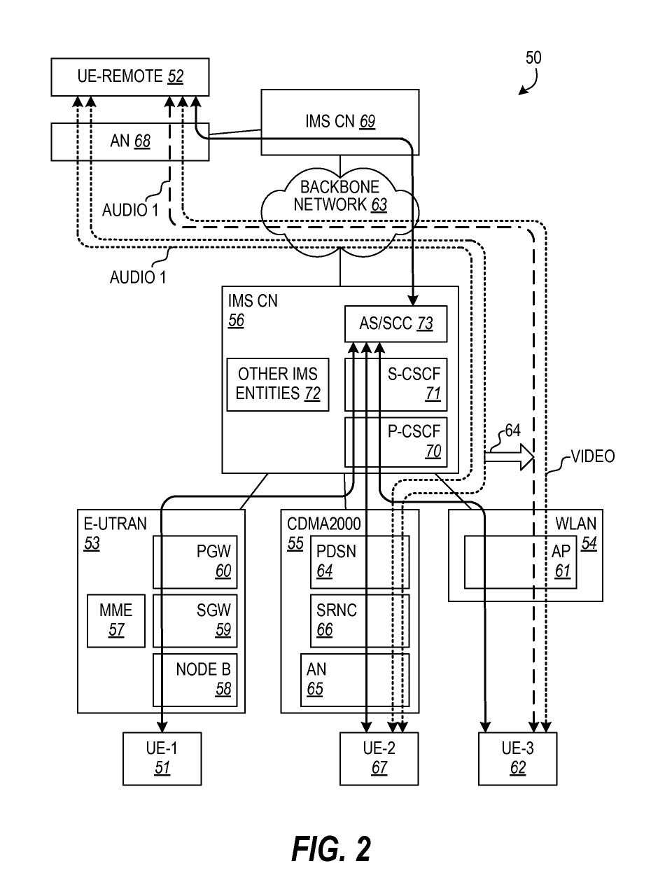

In FIG. 2, in a communication system 50, a first UE (“UE-1”) 51 performs initial communication with a remote node (“UE-remote”) 52. On the user's side, for the sake of simplicity and ease of description, the user is shown as capable of accessing the communication system 50 via three Access Networks (ANs) 53, 54 and 55.

In this example, the AN 53 is a Long Term Evolution (LTE) communication network (i.e., E-UTRAN) capable of providing Internet Protocol (IP) connectivity to multimedia services offered by an IMS CN 56. The AN 53 comprises different network entities such as the Mobility Manager Entity (MME) 57, a Node B 58, a Serving Gateway (SGW) 59, and a Packet Data Network (PDN) Gateway (PGW) 60. A user entity, such as the UE-1 51 which in a mobile device in this example, communicates with the Node B 58 wirelessly at the radio link level.

The AN 54 is a Wireless Local Area Network (WLAN) network, for example, a network operating under the IEEE 802.11 standards and other WLAN technologies. The AN 54 comprises, among other things, an Access Point (AP) 61. Another user device, such as another UE-3 62 can communicate with the AP 61 wirelessly for access of a backbone network 63, for example.

The AN 55 is yet another network, for instance, a CDMA2000 network. The AN 55 includes, among other things, a Packet Data Service Node (PDSN) 64, and Access Node (AS) 65 and a Serving Radio Network Controller (SRNC) 66. As yet another user device, such as another UE-2 67, can communicate with the AN 65 wirelessly for access of the backbone network 63, for instance.

In FIG. 2, all three ANs 53, 54 and 55 are linked to the IMS core network 56. The IMS core network 56 described in this version is a network with an architectural format supported by various standard organizations. Examples are the 3GPP, 3GPP2 (3^{rd} Generation Partnership Project 2), IEEE (International Electrical and Electronic Engineers), etc., to name a few. The IMS core network 56 uses the IP protocols and is connected to the backbone network 63. The backbone network 63 can be the Internet or an intranet.

In FIG. 2, the UEs 51, 62 and 67 are illustrated as connected to the IMS core network 56 via the LTE AN 53, the WLAN AN 54, and the CDMA2000 AN 55, respectively. It should be understood that a single UE may gain access to the IMS core network 56 via one of, any of, or all of the ANs. For instance, the UE-1 51 can gain access to the IMS core network 56 via both the LTE AN 53 and the WLAN AN 54, simultaneously or at different time periods. The same may hold true with the other UEs, such as the UE-2 67 and the UE-3 62.

It should be noted that the types of ANs as described above are merely exemplary. Connections to the IMS core network 56 by other types of ANs are clearly possible.

On the remote user's side, the remote user may also access the network 50 via another AN 68 linked to another IMS core network 69. It should be noted the arrangement shown in FIG. 1 is merely exemplary. Other arrangements are clearly possible. For example, the AN 68 can be the same or different as that used by the user using the UEs UE-1 51 to UE-3 62. Likewise, the IMS core network 69 can be the same or different as that used the user using the UEs UE-1 51- UE-3 62.

In the following description, terminology and protocols associated with signaling and data exchanges according to the IMS standards are used. The fundamentals of the IMS standards can be found in a publication, entitled “Internet Protocol (IP) multimedia call control protocol based on Session Initiation Protocol (SIP) and Session Description Protocol (SDP),” 3GPP TS 24.229, published by the 3GPP.

Suppose initially, there is the UE-1 51 which corresponds with the remote UE-remote 52 via the IMS core network 56. The UE-1 51 gains access to the IMS core network 56 through the AN 53. Likewise, the UE-remote 52 gains access to the IMS core network 69 via the AN 68.

On the user's side, the IMS core network 56 includes a Proxy Call Session Control Function (P-CSCF) server 70, a Serving Call Session Control Function (C-CSCF) server 71, a Session Continuity Controller (SCC)/Application Server (AS) 73 and other IMS entities 72. The SCC AS 73 is one type of application server within the IMS core network 56 that provides functionalities to allow seamless session transfer of communication sessions between different accesses and different devices. In this version, to maintain IMS session continuity, all the IMS sessions are anchored at the SCC AS 73.

In this exemplary version, suppose initially the user controls multiple UEs, such as UE-1 51, UE-2 67 and UE-3 62 and is having an IMS session via the various UEs with the UE-remote 52 comprising multiple multimedia components, namely, audio 1, audio 2 and video. In this disclosure, the term “multi” or “multiple” means more than one. As previously mentioned, the IMS session is anchored at the SCC 73. For example, the multimedia session can be a video conference session with the UE 67 having multiple voice and video streams.

For purposes of description, suppose in this example, the communication session initially has the components audio 1 and audio 2 between the UE-2 67 and the UE-remote 52, as schematically shown in FIG. 2. Further suppose there is also a component video between the UE-3 62 and the UE-remote 52, also as schematically shown in FIG. 2. In this example, the video component is unidirectional with the video stream flowing from the UE-remote 52 to the UE-3 62.

It should be noted that the various UEs, such as UE-1 51, the UE-2 67, the UE-3 62 and the UE-remote 52 also have signaling messages passing through the SCC AS 73. The flows and directions of the signaling messages are shown as thicker solid lines in FIG. 2. On the other hand, the various media components, audio 1, audio 2 and video are represented by dashed lines shown in FIG. 2.

Suppose in the midst of the communication session, the UE-1 51 decides to transfer the audio 1 component from the UE-2 67 to the UE-3 62, as signified by the directional arrow 64 shown in FIG. 2. Here, the UE-1 51 initiates the component transfer and performs the duty of initial signaling and traffic control. The UE-1 51 is called the controller UE. The UE-2 67 and the UE-3 62 on the other hands are called the controllee UEs. It should be noted that the roles of controller and controllee can clearly be switched. For instance, either one of the UE-2 67 or UE-3 62 can assume the role of the controller instead of the UE-1 51.

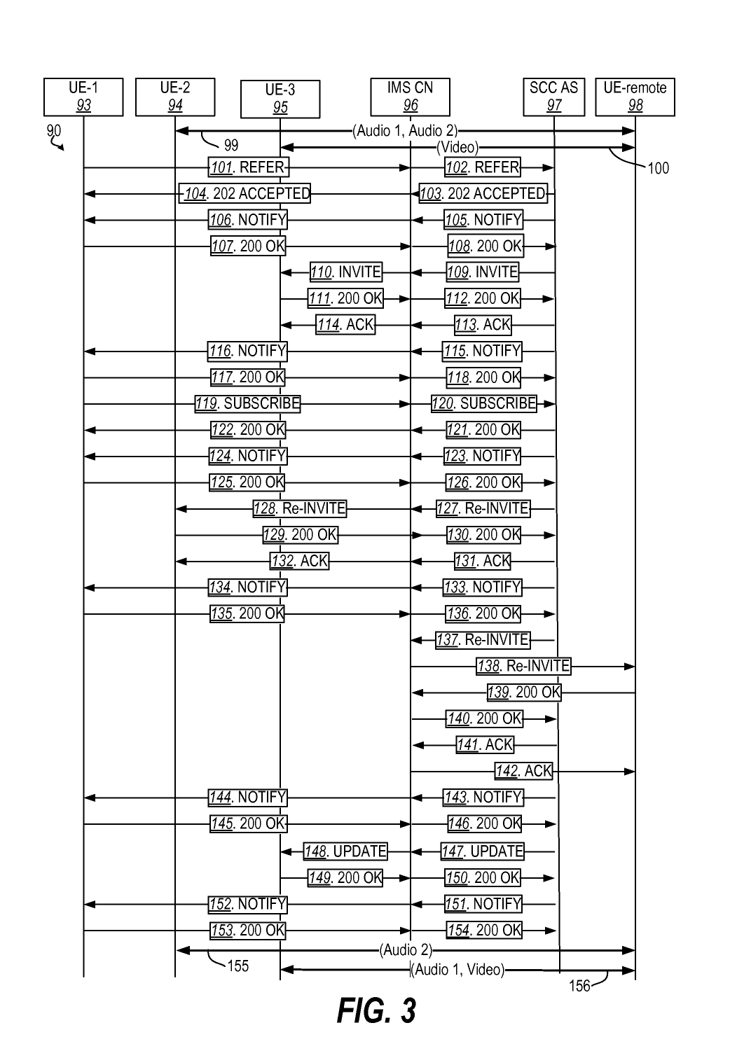

In FIG. 3, an exemplary call flow diagram 90 depicts the signaling and the exchanges of session components between the various entities such as for controller UE initiated media transfer from controllee UE to another controllee UE. In particular, the participants are depicted as UE-1 (controller) 93, UE-2 (controllee) 94, and UE-3 (controllee) 95, an IMS CN 96, a SCC AS 97, and a UE-remote 98. There is an existing session with audio 1 and audio 2 between UE-2 (123.45.67.89) 94, and remote UE (132.54.76.98) 98, depicted at 99. The video component is unidirectional from the remote UE 98 to the controllee UE, UE-3 (123.112.67.87) 95, depicted at 100.

Signaling steps of blocks 101-108 relate to the initiation for session component transfer between the controller UE-1 93 and the SCC AS 97 via the IMS core network 96. The corresponding exemplary messages for the signaling steps of blocks 101-108 are respectively described as sessions in TABLES 1-8.

A SIP REFER request is transmitted from UE-1 93 to SCC-AS 97 via IMS CN 96 (blocks 101-102, respectively). The Controller UE-1 95 attempts to transfer audio 1 portion of this session to the controllee UE, UE-3 95. In TABLE 1, an exemplary Session Initiation Protocol (SIP) REFER request from UE-1 93 to SCC-AS 97 is described:

```
TABLE 1
REFER sip:scc-as@home1.net SIP/2.0
Via:
To: sip:scc-as@home1.net; tag= 24680
From: sip:user1_pubic1@home1.net; tag=13579
Call-ID: cb03a0s09a2sdfglkj490333
CSeq: 93809824 REFER
Max-Forwards: 70
P-Preferred-Identity:
Refer-To: <sip:user1_public3@home1.net;gr=urn:uuid:f81d4fae-
  7dec-11d0-a765-00a0c91e6bf6body=m%3Daudio%200%20RTP%
  2FAVP%200%0Dm%3Daudio%2049174%20RTP%2FAVP%2096%
  0Dm%3Dvideo%201009%20RTP%2FAVP%2098%2099>
Require: target-dialog
Target-dialog: cb03a0s09a2sdfglkj321576;remote-tag=abcdef;local-
tag=123456
Contact: <sip:user1_pubic1@home1.net;gr=urn:uuid:f81d4fae-
  7dec-11d0-a765-00a0c91ewxyz>
Accept: application/sdp, message/sipfrag
Content-Length: 0
```

SIP 202 (Accepted) response is transmitted from SCC AS 97 to UE-1 93 via IMS CN 96 (blocks 103-104, respectively). Thus, SCC-AS 97 sends SIP 202 (Accepted) response to controller UE-1 93 as response to SIP REFER request. SIP NOTIFY request is transmitted from SCC AS 97 to UE-1 93 via IMS CN 96 (blocks 105-106, respectively). Thus, SCC-AS 97 sends SIP NOTIFY request to UE-1 93 to notify implicit subscription to the SIP REFER request results as described in the following TABLE 2:

TABLE 2

NOTIFY
Via:
To: sip:user1_pubic1@home1.net;tag=24680
From: sip:scc-as@home1.net;tag=13579
Call-ID:
CSeq:
Max-Forwards:
P-Asserted-Identity:
Require:
Contact: sip: scc-as@home1.net
Allow:
Event: refer
Subscription-State: active;expires=3600
Content-Type: message/sipfrag;version=2.0
Content-Length: (...)
SIP/2.0 100 Trying

SIP 200 (OK) response is transmitted from UE-1 93 to SCC-AS 97 via IMS CN 96 to acknowledge the SIP NOTIFY request (blocks 107-108, respectively). SIP INVITE request is transmitted from SCC-AS 97 to UE-3 95 via IMS CN 96 (blocks 109-110, respectively).

Steps depicted at blocks 110-114 pertain to setting up the UE-2 95 to be ready for transfer for the session component. The corresponding exemplary messages for the signaling steps depicted as blocks 110-113 are respectively described as in the corresponding sessions.

Since the message of blocks 101-102 contains a Refer-to Header addressed to UE-3 95 and the Uniform Resource Identifier (URI) paramaters, listing an audio line which is not currently supported by another controllee UE other than UE-3 95, the SCC AS 97 realizes that the procedure is for transferring the media from that controllee UE (UE-2 94) to controllee UE (UE-3 95). SCC-AS 97 sends SIP INVITE request to the controllee UE, UE-3 95, to transfer the audio media component. The Session Description Protocol (SDP) in the INVITE lists are the media lines within the collaborative session. In order to avoid UE-3 95 starting to send audio to the remote UE 98, the SCC-AS 97 adds a line to be inactive in the SDP offer as depicted in TABLE 3:

TABLE 3

INVITE sip:user1_public3@home1.net;gr=urn:uuid:f81d4fae-
7dec-11d0-a765-00a0c91e6bf6 SIP/2.0
Via:
To: sip:user1_pubic3@home1.net;
From: sip:scc-as@home1.net; tag=12486
Call-ID:
CSeq:
Max-Forwards:
P-Asserted-Identity:
Require:
Contact:
Allow:
Content-Type: application/sdp
Content-Length: (...)
v=0
o=- 1027933615 1027933615 IN IP4 132.54.76.98
s=-
c=IN IP4 132.54.76.98
t=0 0
m=audio 49174 RTP/AVP 96 97
a=rtpmap:0 PCMU/8000
a=inactive
m=audio 0 RTP/AVP 0
m=video 1009 RTP/AVP 98 99
a=sendonly
b=AS:75
a=rtpmap:98 H263
a=fmtp:98 profile-level-id=0
a=rtpmap:99 MP4V-ES

SIP 200 (OK) response is transmitted from UE-3 95 to SCC-AS 97 via IMS CN 96 (blocks 111-112, respectively). Thereby, the controllee UE, UE-3 95, acknowledges the SIP INVITE request by sending SIP 200 (OK) response to SCC-AS 97, as described in an exemplary TABLE 4:

TABLE 4

SIP/2.0 200 OK
Via:
To: sip:user1_pubic3@home1.net; tag = xyzwv
From: sip:scc-as@home1.net; tag = 12486
Call-ID:
CSeq:
P-Preferred-Identity:
Contact: sip:user1_pubic3@home1.net;gr=urn:uuid:f81d4fae-
7dec-11d0-a765-00a0c91e6bf6
Allow:
Content-Type: application/sdp
Content-Length: (...)
v=0
o=- 1027933615 1027933615 IN IP4 123.112.67.87
s=-
c=123.112.67.87
t=0 0
m=audio 3002 RTP/AVP 96 97
a=rtpmap:0 PCMU/8000
a=inactive
m=audio 0 RTP/AVP 0
m=video 1302 RTP/AVP 98 99
a=recvonly
b=AS:75
a=rtpmap:98 H263
a=fmtp:98 profile-level-id=0
a=rtpmap:99 MP4V-ES

SIP ACK request is transmitted from SCC-AS 97 to UE-3 95 via IMS CN 96 to acknowledge (block 113, 114, respectively).

Steps depicted as blocks 115-118 relate to the notification to the controller UE-1 93 and acknowledgement by the controller UE-1 93 of status of the transfer request to the controllee UE-2 95 in regard to whether the INVITE message in step depicted as block 109 has been successfully sent to the UE-2 95 for the session component transfer. SIP NOTIFY request is transmitted from SCC-AS 97 to controller UE, UE-1 93 (blocks 115-116, respectively). Thereby, SCC-AS 97 sends SIP NOTIFY request to controller UE, UE-1 93, to inform about the success status of the transfer of Audio 1 to controllee UE-3 95. An exemplary message content is provided in TABLE 5:

TABLE 5

NOTIFY
Via:
To: sip:user1_pubic1@home1.net; tag=13579
From: sip:scc-as@home1.net; tag=24680
Call-ID:
CSeq:
Max-Forwards:
P-Asserted-Identity:
Require:
Contact: sip: scc-as@home1.net
Allow:
Event: refer
Subscription-State:terminated; reason=noresource
Content-Type: message/sipfrag ;version=2.0
Content-Length: (...)
SIP/2.0 200 OK
Content-Type:application/sdp
m=audio 3002 RTP/AVP 96 97
a=rtpmap:0 PCMU/8000
a=inactive
m=audio 0 RTP/AVP 0
m=video 1302 RTP/AVP 98 99
a=recvonly
c=123.112.67.87
b=AS:75
a=rtpmap:98 H263
a=fmtp:98 profile-level-id=0
a=rtpmap:99 MP4V-ES

SIP 200 (OK) response (from controller UE 93 to SCC-AS 97 (blocks 117-118, respectively). Thus, the controller UE 93 acknowledges the SIP NOTIFY request by sending SIP 200 (OK) response to SCC-AS 97. Thus, steps depicted as blocks 119-126 involve the initial subscription and notification by the controller UE-1 93 to the SCC AS 97. During subscription in steps depicted as blocks 119-120, the UE-1 93 subscribes to the dialog event package between the UE-1 93 and the SCC AS 97. However, since this dialog between the UE-1 93 and the SCC AS 97 is the dialog for controlling the collaborative session, the SCC AS 97 treats this subscription as subscribing to the session information for the entire collaborative session.

SIP SUBSCRIBE request is transmitted from SCC-AS 97 to controllee UE, UE-2 94 to subscribe to the existing dialog between the controller UE UE-1 93 and the SCC AS 97 (blocks 119-120, respectively). TABLE 6 provides an exemplary description:

TABLE 6

SUBSCRIBE sip:scc-as@home1.net SIP/2.0
Via:
To: sip:scc-as@home1.net; tag=24680
From: sip:user1 _pubic1@home1.net; tag=13579
Call-ID: cb03a0s09a2sdfglkj490333
CSeq: 1 SUBSCRIBE
Max-Forwards: 70
P-Preferred-Identity:
Require: target-dialog
Target-dialog:
cb03a0s09a2sdfglkj321576;remote-tag=abcdef;local-tag=123456
Contact: sip:user1 _pubic1@home1.net;gr=urn:uuid:f81d4fae-
7dec-11d0-a765-00a0c91ewxyz
CSeq:
Allow:
Accept: application/dialog-info+xml
Content-Type: application/sdp, message/sipfrag ;version=2.0
Content-Length: 0

SIP 200 (OK) response is transmitted from SCC-AS 97 to controller UE, UE-1 93 to acknowledge the SIP SUBSCRIBE request (blocks 121-122, respectively). SIP NOTIFY request is transmitted from SCC-AS 97 to controller UE, UE-1 93, via IMS CN 96 (blocks 123-124, respectively). The SIP NOTIFY request contains SDP for controllee UE-2 94, controllee UE-3 95, and the remote UE 98 as provided in TABLE 7:

TABLE 7

```
NOTIFY sip:user1 _pubic1@home1.net;
Via:
To: sip:user1 _pubic1@home1.net; tag=13579
From: sip:scc-as@home1.net; tag=24680
Call-ID:
CSeq:
Max-Forwards:
P-Asserted-Identity:
Require:
Contact: sip: scc-as@home1.net
Allow:
Accept: application/dialog-info+xml
Content-Type: application/sdp, message/sipfrag ;version=2.0 ;
  application/dialog-info+xml
Content-Length: (...)
<?xml version=“1.0” encoding=“UTF-8”?>
<xs:schema xmlns:xs=“http://www.w3.org/2001/XMLSchema”
  elementFormDefault=“qualified”
        attributeFormDefault=“unqualified” version=“1”>
<xs:element name=“session-description” type=“tns:sessd”
      minOccurs=“0” maxOccurs=“1”/>
<xs:complexType name=“sessd”>
    <xs:simpleContent>
      <xs:extension base=“xs:string”>
      <xs:attribute name=“type” type=“xs:string”
                  use=“required”/>
m=audio 75875 RTP/AVP
c=IN IP4 123.112.67.87
m=audio 34002 RTP/AVP 96 97
c=IN IP4 123.112.67.87
a=rtpmap:0 PCMU/8000
m=video 0 RTP/AVP 0
m=audio 3002 RTP/AVP 96 97
c=123.112.67.87
a=rtpmap:0 PCMU/8000
a=inactive
m=audio 0 RTP/AVP 0
c=123.112.67.87
m=video 1302 RTP/AVP 98 99
c=123.112.67.87
a=recvonly
b=AS:75
a=rtpmap:98 H263
a=fmtp:98 profile-level-id=0
a=rtpmap:99 MP4V-ES
m=audio 49174 RTP/AVP 96 97
c= IN IP4 132.54.76.98
b=AS:25.4
a=rtpmap:96 AMR
a=fmtp:96mode-set=0,2,5,7; mode-change-period=2
a=rtpmap:97 telephone-event
a=maxptime:20
m=audio 44552 RTP/AVP 96 97
c= IN IP4 132.54.76.98
a=rtpmap:0 PCMU/8000
m=video 1009 RTP/AVP 98 99
c= IN IP4 132.54.76.98
a=sendonly
b=AS:75
a=rtpmap:98 H263
a=fmtp:98 H263
a=fmtp:98 profile-level-id=0
a=rtpmap:99 MP4V-ES
      </xs:extension>
    </xs:simpleContent>
    </xs:complexType>
</xs:schema>
```

SIP 200 (OK) response is transmitted from controllee UE-2 94 to SCC-AS 97 via IMS CN 96 to acknowledge the SIP NOTIFY (blocks 125-126, respectively).

Steps depicted as blocks 127-132 concern with updating the dialog of the controllee UE-2 94 with regard to the media component being transferred away from the controllee UE-2 94. SIP re-INVITE request is transmitted from SCC-AS 97 to controllee UE, UE-2 94, via IMS CN 96 to release Audio 1 (blocks 127-128, respectively). TABLE 8 depicts an exemplary SIP INVITE request:

TABLE 8

INVITE sip:user1 _public2@home3.net;gr=urn:uuid:f81d4fae-
7dec-11d0-a765-00a0c91e6bf6 SIP/2.0
Via:
To: sip:user1 _pubic2@home1.net;
From: sip:scc-as@home1.net; tag=12386
Call-ID:
CSeq:
Max-Forwards:
P-Asserted-Identity:
Require:
Contact:
Allow:
Content-Type: application/sdp
Content-Length: (...)
v=0
o=- 1027933615 1027933615 IN IP4 123.112.67.87
s=-
c=IN IP4 123.112.67.87
t=0 0
m=audio 0 RTP/AVP 0
m=audio 44552 RTP/AVP 96 97
a=rtpmap:0 PCMU/8000

SIP 200 (OK) response is transmitted from UE-2 94 to SCC-AS 97 via IMS CN 96 to acknowledge the SIP INVITE request (blocks 129-130, respectively). TABLE 9 depicts an exemplary SIP 200 OK response:

TABLE 9

SIP/2.0 200 OK
Via:
To: sip:user1 _pubic2@home1.net; tag = xyzwv
From: sip:scc-as@home1.net; tag = 12486
Call-ID:
CSeq:
P-Preferred-Identity:
Contact: sip:user1 _pubic2@home1.net;gr=urn:uuid:f81d4fae-
7dec-11d0-a765-00a0c91e6bf6
Allow:
Content-Type: application/sdp
Content-Length: (...)
v=0
o=- 1027933615 1027933615 IN IP4 123.45.67.89
s=-
c=IN IP4 123.45.67.89
t=0 0
m=audio 0 RTP/AVP 0
m=audio 34002 RTP/AVP 96 97
a=rtpmap:0 PCMU/8000

SIP ACK request is transmitted from SCC-AS 97 to UE-2 94 via IMS CN 96 to acknowledge (blocks 131-132, respectively).

Steps depicted as blocks 133-154 pertain to the final acknowledgment and confirmation among the various entities with respect to the transfer of the audio 1 component from the controllee UE-2 94 to the other controllee UE-2 95. More specifically, steps depicted as blocks 133-134, 143-144, 151 and 152 are sent in response to the subscription in steps depicted as blocks 119-120. In particular, steps depicted as blocks 133-134 notify the UE-1 93 of the dialog status change on the dialog between the UE-1 93 and the SCC AS 97. Steps depicted as blocks 143-144 notify the UE-1 93 of the dialog between the UE remote 98 and the SCC AS 97. Steps 151-152 notify the UE-1 93 of the dialog between the UE-2 95 and the SCC AS 97. After these steps, the audio 1 component is thereafter transferred, as depicted in FIG. 2.

In particular, SIP NOTIFY request is transmitted from SCC-AS 97 to controller UE-1 93 (blocks 133-134, respectively). The SIP NOTIFY request contains SDP for controllee UE-2 94, controllee UE-3 95, and the remote UE 98 as depicted in

TABLE 10

```
NOTIFY sip:user1 _pubic1@home1.net;
Via:
To: sip:user1 _pubic1@home1.net; tag=13579
From: sip:scc-as@home1.net; tag=24680
Call-ID:
CSeq:
Max-Forwards:
P-Asserted-Identity:
Require:
Contact: sip: scc-as@home1.net
Allow:
Accept: application/dialog-info+xml
Content-Type: application/sdp, message/sipfrag ;version=2.0 ;
  application/dialog-info+xml
Content-Length: (...)
<xs:element name=“session-description” type=“tns:sessd”
      minOccurs=“0” maxOccurs=“1”/>
<xs:complexType name=“sessd”>
    <xs:simpleContent>
      <xs:extension base=“xs:string”>
      <xs:attribute name=“type” type=“xs:string”
                  use=“required”/>
m=audio 0 RTP/AVP 0
c=IN IP4 123.112.67.87
m=audio 34002 RTP/AVP 96 97
c=IN IP4 123.112.67.87
a=rtpmap:0 PCMU/8000
m=video 0 RTP/AVP 0
m=audio 3002 RTP/AVP 96 97
c=123.112.67.87
a=rtpmap:0 PCMU/8000
a=inactive
m=audio 0 RTP/AVP 0
c=123.112.67.87
m=video 1302 RTP/AVP 98 99
c=123.112.67.87
a=recvonly
b=AS:75
a=rtpmap:98 H263
a=fmtp:98 profile-level-id=0
a=rtpmap:99 MP4V-ES
m=audio 49174 RTP/AVP 96 97
c= IN IP4 132.54.76.98
b=AS:25.4
a=rtpmap:96 AMR
a=fmtp:96mode-set=0,2,5,7; mode-change-period=2
a=rtpmap:97 telephone-event
a=maxptime:20
m=audio 44552 RTP/AVP 96 97
c= IN IP4 132.54.76.98
a=rtpmap:0 PCMU/8000
m=video 1009 RTP/AVP 98 99
c= IN IP4 132.54.76.98
a=sendonly
b=AS:75
a=rtpmap:98 H263
a=fmtp:98 H263
a=fmtp:98 profile-level-id=0
a=rtpmap:99 MP4V-ES
      </xs:extension>
    </xs:simpleContent>
    </xs:complexType>
```

SIP 200 (OK) response is transmitted from controllee UE-2 94 to SCC-AS 97 via IMS CN 96 to acknowledge the SIP NOTIFY request (blocks 135-136, respectively). SIP re-INVITE request is transmitted from SCC-AS 97 to remote UE 98 via IMS CN 96 (blocks 137, 138 respectively). TABLE 11 depicts an exemplary SIP re-INVITE request:

TABLE 11

INVITE sip:user2_public1@home3.net;SIP/2.0
Via:
To: sip:user2_pubic1@home2.net;tag=66666
From: sip:scc-as@home1.net; tag=33333
Call-ID:
CSeq:
Max-Forwards:
P-Asserted-Identity:
Require:
Contact:sip:user1 _public1@home1.net;gr=urn:uuid:f81d4fae-
7dec-11d0-a765-00a0c91ewxyz
Allow:
Content-Type: application/sdp
Content-Length: (...)
v=0
o=- 1027933615 1027933615 IN IP4 123.112.67.87
s=-
t=0 0
m=audio 3002 RTP/AVP 96 97
c= IN IP4 123.112.67.87
a=rtpmap:0 PCMU/8000
m=audio 34002 RTP/AVP 96 97
C=IN IP4 123.45.67.89
A=rtpmap:0 PCMU/8000
m=video 1302 RTP/AVP 98 99
c= IN IP4 123.112.67.87
b=AS:75
a=rtpmap:98 H263
a=fmtp:98 profile-level-id=0
a=rtpmap:99 MP4V-ES

SIP 200 (OK) response is transmitted from remote UE 98 to SCC-AS 97 via IMS CN 96 to acknowledge the SIP re-INVITE request (blocks 139-140, respectively). TABLE 12 depicts an exemplary SIP 200 (OK) response:

TABLE 12

SIP/2.0 200 OK
Via:
To:
From:
Call-ID:
CSeq:
P-Asserted-Identity:
Contact: sip:user2_pubic1@home2.net;
Allow:
Content-Type: application/sdp
Content-Length: (...)
v=0
o=- 1027933615 1027933615 IN IP4 132.54.76.98
s=-
c= IN IP4 132.54.76.98
t=0 0
m=audio 49174 RTP/AVP 96 97
b=AS:25.4
a=rtpmap:96 AMR
a=fmtp:96mode-set=0,2,5,7; mode-change-period=2
a=rtpmap:97 telephone-event
a=maxptime:20
m=audio 44552 RTP/AVP 96 97
a=rtpmap:0 PCMU/8000
m=video 1009 RTP/AVP 98 99
a=sendonly
b=AS:75
a=rtpmap:98 H263
a=fmtp:98 H263
a=fmtp:98 profile-level-id=0
a=rtpmap:99 MP4V-ES

SIP ACK request is transmitted from SCC-AS 97 to remote UE 98 via IMS CN 96 (blocks 141-142, respectively). SIP NOTIFY request is transmitted from SCC-AS 97 to controller UE-1 93 via IMS CN 96 (blocks 143-144, respectively). TABLE 13 depicts an exemplary SIP NOTIFY request containing SDP for controllee UE-2 94, controllee UE-3 95, and the remote UE 98:

TABLE 13

```
NOTIFY sip:user1 _pubic1@home1.net;
Via:
To: sip:user1 _pubic1@home1.net; tag=13579
From: sip:scc-as@home1.net; tag=24680
Call-ID:
CSeq:
Max-Forwards:
P-Asserted-Identity:
Require:
Contact: sip: scc-as@home1.net
Allow:
Accept: application/dialog-info+xml
Content-Type: application/sdp, message/sipfrag ;version=2.0 ;
  application/dialog-info+xml
Content-Length: (...)
<xs:element name=“session-description” type=“tns:sessd”
      minOccurs=“0” maxOccurs=“1”/>
<xs:complexType name=“sessd”>
    <xs:simpleContent>
      <xs:extension base=“xs:string”>
      <xs:attribute name=“type” type=“xs:string”
                  use=“required”/>
m=audio 75875 RTP/AVP
c=IN IP4 123.112.67.87
m=audio 34002 RTP/AVP 96 97
c=IN IP4 123.112.67.87
a=rtpmap:0 PCMU/8000
m=video 0 RTP/AVP 0
m=audio 3002 RTP/AVP 96 97
c=123.112.67.87
a=rtpmap:0 PCMU/8000
a=inactive
m=audio 0 RTP/AVP 0
c=123.112.67.87
m=video 1302 RTP/AVP 98 99
c=123.112.67.87
a=recvonly
b=AS:75
a=rtpmap:98 H263
a=fmtp:98 profile-level-id=0
a=rtpmap:99 MP4V-ES
m=audio 49174 RTP/AVP 96 97
c= IN IP4 132.54.76.98
b=AS:25.4
a=rtpmap:96 AMR
a=fmtp:96mode-set=0,2,5,7; mode-change-period=2
a=rtpmap:97 telephone-event
a=maxptime:20
m=audio 44552 RTP/AVP 96 97
c= IN IP4 132.54.76.98
a=rtpmap:0 PCMU/8000
m=video 1009 RTP/AVP 98 99
c= IN IP4 132.54.76.98
a=sendonly
b=AS:75
a=rtpmap:98 H263
a=fmtp:98 H263
a=fmtp:98 profile-level-id=0
a=rtpmap:99 MP4V-ES
      </xs:extension>
    </xs:simpleContent>
    </xs:complexType>
```

SIP 200 (OK) response is transmitted from controllee UE-2 94 to SCC-AS 97 via IMS CN 96 to acknowledge the SIP NOTIFY request (blocks 145-146, respectively). SIP UPDATE request is transmitted from SCC-AS 97 to controllee UE; UE-3 95, via IMS CN 96 to activate the audio 1 media component (blocks 147-148, respectively). TABLE 14 depicts an exemplary SIP UPDATE request:

TABLE 14

UPDATE sip:user1 _public3@home1.net;gr=urn:uuid:f81d4fae-
7dec-11d0-a765-00a0c91e6bf6 SIP/2.0
Via:
To: sip:user1 _pubic3@home1.net;
From: sip:scc-as@home1.net; tag=12486
Call-ID:
CSeq:
Max-Forwards:
P-Asserted-Identity:
Require:
Contact:
Allow:
Content-Type: application/sdp
Content-Length: (...)
v=0
o=- 1027933615 1027933615 IN IP4 123.112.67.87
s=-
c=IN IP4 123.112.67.87
t=0 0
m=audio 49174 RTP/AVP 96 97
a=rtpmap:0 PCMU/8000
a=active
m=audio 0 RTP/AVP 0
m=video 1009 RTP/AVP 98 99
b=AS:75
a=rtpmap:98 H263
a=fmtp:98 profile-level-id=0
a=rtpmap:99 MP4V-ES

SIP 200 (OK) response is transmitted from controllee UE, UE-3 95, to SCC AS 97 via IMS CN 96 (blocks 149-150, respectively). SIP NOTIFY request is transmitted from SCC-AS 97 to controller UE-1 93 via IMS CN 96 (blocks 151-152, respectively). TABLE 15 depicts an exemplary SIP NOTIFY request containing SDP for controllee UE-2 94, controllee UE-3 95, and the remote UE 98:

TABLE 15

```
NOTIFY sip:user1 _pubic1@home1.net;
Via:
To: sip:user1 _pubic1@home1.net; tag=13579
From: sip:scc-as@home1.net; tag= 24680
Call-ID:
CSeq:
Max-Forwards:
P-Asserted-Identity:
Require:
Contact: sip: scc-as@home1.net
Allow:
Accept: application/dialog-info+xml
Content-Type: application/sdp, message/sipfrag ;version=2.0 ;
  application/dialog-info+xml
Content-Length: (...)
<xs:element name=“session-description” type=“tns:sessd”
      minOccurs=“0” maxOccurs=“1”/>
<xs:complexType name=“sessd”>
    <xs:simpleContent>
      <xs:extension base=“xs:string”>
      <xs:attribute name=“type” type=“xs:string”
                  use=“required”/>
m=audio 75875 RTP/AVP
c=IN IP4 123.112.67.87
m=audio 34002 RTP/AVP 96 97
c=IN IP4 123.112.67.87
a=rtpmap:0 PCMU/8000
m=video 0 RTP/AVP 0
m=audio 3002 RTP/AVP 96 97
c=123.112.67.87
a=rtpmap:0 PCMU/8000
a=active
m=audio 0 RTP/AVP 0
c=123.112.67.87
m=video 1302 RTP/AVP 98 99
c=123.112.67.87
a=recvonly
b=AS:75
a=rtpmap:98 H263
a=fmtp:98 profile-level-id=0
a=rtpmap:99 MP4V-ES
m=audio 49174 RTP/AVP 96 97
c= IN IP4 132.54.76.98
b=AS:25.4
a=rtpmap:96 AMR
a=fmtp:96mode-set=0,2,5,7; mode-change-period=2
a=rtpmap:97 telephone-event
a=maxptime:20
m=audio 44552 RTP/AVP 96 97
c= IN IP4 132.54.76.98
a=rtpmap:0 PCMU/8000
m=video 1009 RTP/AVP 98 99
c= IN IP4 132.54.76.98
a=sendonly
b=AS:75
a=rtpmap:98 H263
a=fmtp:98 H263
a=fmtp:98 profile-level-id=0
a=rtpmap:99 MP4V-ES
      </xs:extension>
    </xs:simpleContent>
    </xs:complexType>
```

SIP 200 (OK) response is transmitted from controllee UE-2 94 to SCC-AS 97 via IMS CN 96 to acknowledge the SIP NOTIFY request (blocks 153-154, respectively). Thus, media transfer is then audio 2 between UE-2 94 and UE-remote 98 as depicted at 155 and audio 1 and video between UE-3 95 and UE-remote 98 as depicted at 156.

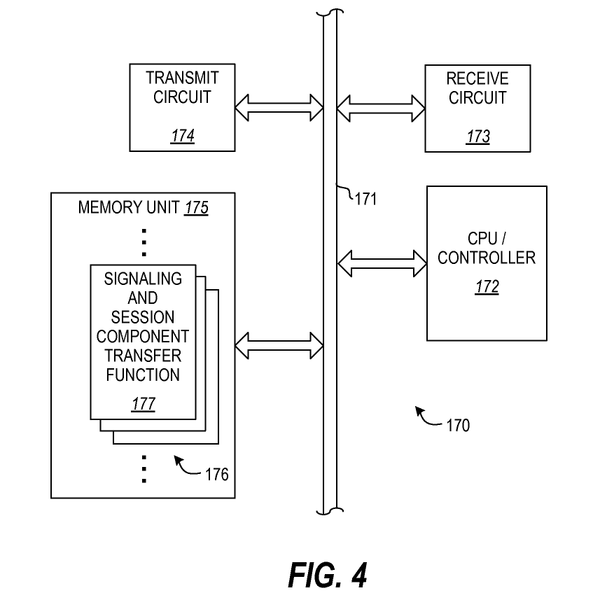

FIG. 4 shows the part of hardware implementation of an apparatus for executing the schemes or processes wherein an implicit subscription is not terminated after a collaborative session is established. The circuit apparatus is signified by the reference numeral 170 and can be implemented in a user entity, such as the UEs 51, 52, 62 and 67, or a network entity, such as the SCC AS 73 of FIG. 2 and other applicable communication entities.

The apparatus 170 comprises a central data bus 171 linking several circuits together. The circuits include a CPU (Central Processing Unit) or a controller 172, a receive circuit 173, a transmit circuit 174, and a memory unit 175.

If the apparatus 170 is part of a wireless device, receive and transmit circuits 173 and 174 can be connected to a RF (Radio Frequency) circuit but is not shown in the drawing. The receive circuit 173 processes and buffers received signals before sending out to the data bus 171. On the other hand, the transmit circuit 174 processes and buffers the data from the data bus 171 before sending out of the device 170. The CPU/controller 172 performs the function of data management of the data bus 171 and further the function of general data processing, including executing the instructional contents of a memory unit 175.

The memory unit 175 includes a set of modules and/or instructions generally signified by the reference numeral 176. In the exemplary aspect, the modules/instructions include, among other things, a signaling and session component transfer function 177 which carries out the schemes and processes as described above. The function 177 includes computer instructions or code for executing the process steps as shown and described in FIGS. 1-3. Specific instructions particular to an entity can be selectively implemented in the function 177. For instance, if the apparatus 170 is part of a user entity such as the UE-1 51 (FIG. 2), among other things, instructions particular to the user entity as shown and described in FIG. 1-3 can be coded in the functions 177. Similarly, if the apparatus 170 is part of an infrastructure communication entity or a network entity, for example an SCC AS 73, instructions particular to the aspects of the infrastructure entity as shown and described in FIG. 1-3 can be coded in the function 177.

In this version, the memory unit 175 is a RAM (Random Access Memory) circuit. The exemplary functions, such as the signaling and session component transfer function 177, are software routines, modules and/or data sets. The memory unit 175 can be tied to another memory circuit (not shown) which either can be of the volatile or nonvolatile type. As an alternative, the memory unit 175 can be made of other circuit types, such as an EEPROM (Electrically Erasable Programmable Read Only Memory), an EPROM (Electrical Programmable Read Only Memory), a ROM (Read Only Memory), a magnetic disk, an optical disk, and others well known in the art.

Furthermore, the memory unit 175 can be an application specific integrated circuit (ASIC). That is, the instructions or code in the function 177 can be hard-wired or implemented by hardware, or a combination of hardware and software thereof.

In addition, the memory unit 175 can be a combination of ASIC and memory circuitry built of the volatile type and/or non-volatile type.

It should be further be noted that the inventive processes as described can also be coded as computer-readable instructions carried on any computer-readable medium known in the art. In this disclosure, the term “computer-readable medium” refers to any medium that participates in providing instructions to any processor, such as the CPU/controller 172 shown and described in the drawing figure of FIG. 4, for execution. Such a medium can be of the storage type and may take the form of a volatile or non-volatile storage medium as also described previously, for example, in the description of the memory unit 175 in FIG. 4. The computer-readable medium can be part of a computer program product separate from the apparatus 170.

The innovative processes as described can also be coded as computer-readable instructions or code can be transmitted via a transmission medium which may include a coaxial cable, a copper wire, an optical cable, and the air interface carrying acoustic, electromagnetic or optical waves capable of carrying signals readable by machines or computers (i.e., “transitory”). The transmission medium can also be part of a computer program product separate from the apparatus 170. In an exemplary aspect, the computer-readable instructions or codes are non-transitory.

Finally, other changes are possible within the scope of the invention. For instance, described in the exemplary aspect the remote user is depicted as operating only the UE-remote 52 (FIG. 2). The user of the UE-remote 52 can operate multiple communication devices in a collaborative session, in a manner similar to that as described for the user of the UEs, 51, 67 and 62. Furthermore, in aspects as described, each of the UEs 51, 67 and 62 is described as accessing the communication system 50 via separate ANs 53, 55 and 54, respectively, of different AN technologies. This need not be the case. All or some of the ANs can certainly be of the same AN technology. Other than as described above, any other logical blocks, circuits, and algorithm steps described in connection with the embodiment can be implemented in hardware, software, firmware, or combinations thereof. It will be understood by those skilled in the art that theses and other changes in form and detail may be made therein without departing from the scope and spirit of the invention.

The present innovation also relates to the use of NOTIFY of REFER request to monitor the status of the media(s)/session(s) in a Collaborative Session. In this REFER-based solution for an Inter-UE Transfer (IUT), a REFER message with XML body can be used to initiate all IUT operations. A NOTIFY message with SIP frag body can be used to notify the controller UE of IUT operation results and other related information. A duration other than

RFC 3420 defined a conventional message/sipfrag Multipurpose Internet Mail Extensions (MIME) media type. This type is similar to message/sip, but allows certain subsets of well-formed Session Initiation Protocol (SIP) messages to be represented instead of requiring a complete SIP message. In addition to end-to-end security uses, message/sipfrag can be used with the REFER method to convey information about the status of a referenced request. TABLE 16 depicts a data structure for a REFER message:

TABLE 16

```
REFER
Refer-To:
Target-Dialog:
<iut_operation>
  <op code></op code>
  <media_reference> </media_reference>
  <media_type></media_type>
  <source_uri> </source_uri>
  <target_uri> </target_uri>
</iut_operation>
```

IUT of media from controller to controllee, a REFER message with the following information can be used to perform the operation, wherein the underlined portion would be replaced with exemplary device/session information:

```
TABLE 17
REFER
Refer-To: controllee UE URI
Target-Dialog: dialog-ID of controller-AS session
<iut_operation>
  <op code>Transfer</op code>
  <media_reference> controller UE: m line number</media_reference>
  <media_type>video</media_type>
  <source_uri> controller UE uri</source_uri>
  <target_uri> controllee UE uri</target_uri>
</iut_operation>
```

With regard to notification of the result of IUT operations, the controller UE uses NOTIFY with sipfrag. In a successful case, the final agreed SDP is also included as part of the sipfrag so that the controller UE is aware of the media information on the controllee. In a failure case, the final error response is included in the NOTIFY.

With regard, to IUT adding media to controllee, a REFER message with the following information can be used to perform the operation:

TABLE 18

```
REFER
Refer-To: controllee UE URI
Target-Dialog: dialog-ID of controller-AS session
<iut_operation>
  <op code>Add</op code>
  <media_reference> </media_reference>
  <media_type>video</media_type>
  <source_uri> </source_uri>
  <target_uri> controllee UE uri</target_uri>
</iut_operation>
```

NOTIFY can be used to notify the results.

For IUT of media from one controllee to another controllee, a REFER message with the following information can be used to perform the operation:

TABLE 19

```
REFER
Refer-To: source controllee UE URI
Target-Dialog: dialog-ID of controller-AS session
<iut_operation>
  <op code>Transfer</op code>
  <media_reference> source controller UE: m line
  number</media_reference>
  <media_type>video</media_type>
  <source_uri> source controllee UE uri</source_uri>
  <target_uri> target controllee UE uri</target_uri>
</iut_operation>
```

NOTIFY can be used to notify the results. In a successful case, the final agreed SDP on target controllee UE is included in sipfrag. In a failure case, the error response from either the source or target UE is included depending on where the error occurs.

For IUT removing media from controllee, a REFER message with the following information can be used to perform the operation:

```
TABLE 20
REFER
Refer-To: controllee UE URI
Target-Dialog: dialog-ID of controller-AS session
<iut_operation>
  <op code>Remove</op code>
  <media_reference> controllee UE: m line number</media_reference>
  <media_type>video</media_type>
  <source_uri> </source_uri>
  <target_uri> controllee UE uri</target_uri>
</iut_operation>
```

NOTIFY with sipfrag can be used to notify the operation results.

For IUT retrieval of media from controllee to controller, a REFER message with the following information can be used to perform the operation:

```
TABLE 21
REFER
Refer-To: controllee UE URI
Target-Dialog: dialog-ID of controller-AS session
<iut_operation>
  <op code>Transfer</op code>
  <media_reference> controllee UE: m line number</media_reference>
  <media_type>video</media_type>
  <source_uri> controllee UE uri</source_uri>
  <target_uri> controller UE uri</target_uri>
</iut_operation>
```

Re-INVITE is used to update the media between controller UE and the AS. NOTIFY with sipfrag is used to notify the operation results. When a controllee releases media or change media characteristics, the controller UE needs to be notified of the change. This is can be initiated by either the controllee itself or the remote party. NOTIFY with sipfrag is used to notify the release or changes.

TABLE 22

NOTIFY
Call-ID: the call-id created by the original REFER
(sipfrag body:
BYE from the controllee UE to the AS)

TABLE 23

NOTIFY
Call-ID: the call-id created by the original REFER
(sipfrag body:
Re-INVITE from the controllee UE to the AS)

For IUT Controller directing new media from remote party to a controllee, the re-INVITE from the remote party will always be directed to the controller UE first. The rest of the inter-UE transfer operation is the same as transferring media from the controller to the controllee.

For non IUT operation handling, consider the following operations that do not include inter-UE procedures:
Controller adding media to controller;
Controller removing media from controller; and
Remote party initiated media addition/removal/modification on the controller.

Normal IMS procedures are used to handle the above cases.

The following operations affects all UEs within the collaborative session, but are common for all options:
Controller UE initiated session release; and
Remote party initiated session release.
   The AS needs to release all controlled sessions on the controllee UEs.

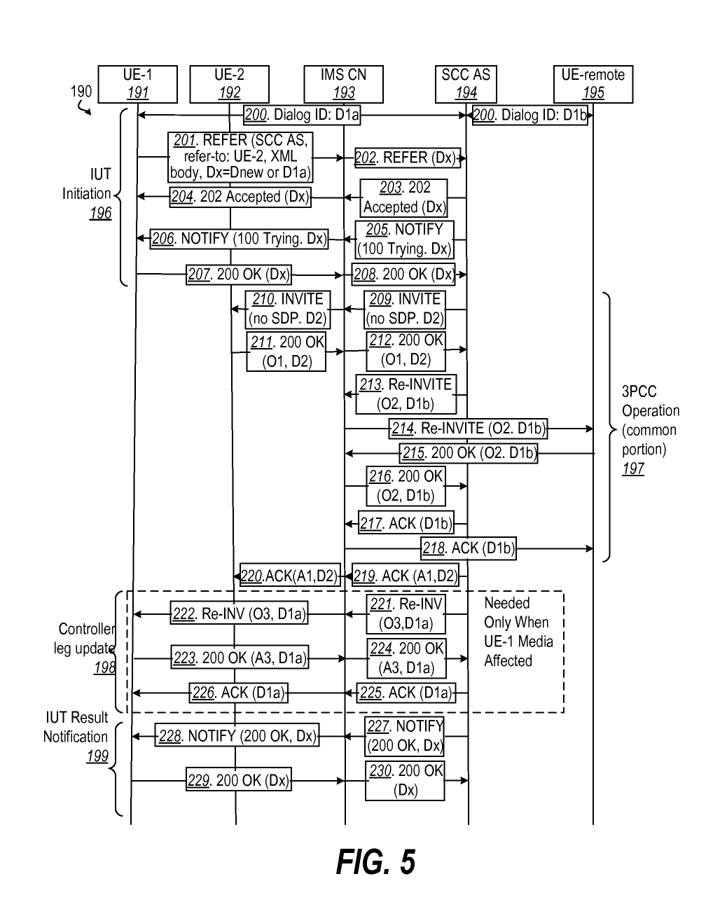

In FIG. 5, a REFER-based methodology 190 is provided for monitoring media sessions in a collaborative session involving controller UE-1 191, controllee UE-2 192, IMS CN 193, SCC AS 194 and UE-remote 195. At a high level, the methodology 190 begins with an Inter-UE transfer (IUT) initiation portion 196, then a Third Party Call Control (3PCC) operation 197 that can be common to various disclosed aspects, a controller leg update 198, and IUT result notification 199.

With particular reference to IUT initiation portion 196, Dialog ID D1a exists between Controller UE-1 191 and UE-remote 195 via SCC AS 194 (block 200). Controller UE-1 191 transmits to IMS CN 193 a REFER message (SCC AS, refer-to: UE-2, XML body, Dx=Dnew or D1a) (block 201). In turn, the IMS CN 193 transmits to SCC AS 194 a REFER (Dx) (block 202). In response, the SCC AS 194 transmits a 202 Accepted (Dx) to the IMS CN 193 (block 203), which in turn transmits to UE-1 191 a 202 Accepted (Dx) (block 204). The SCC AS 194 transmits a NOTIFY (100 Trying, Dx) to the IMS CN 193 (block 205), which in turn transmits to UE-1 191 a NOTIFY (100 Trying, Dx) (block 206). The UE-1 191 transmits 200 OK (Dx) to the IMS CN 193 (block 207), which in turn transmits 200 OK (Dx) to SCC AS 194 (block 208).

With regard to 3PCC operation 197, SCC AS 194 transmits to the IMS CN 193 an INVITE (no SDP, D2) (block 209), which in turn transmits INVITE (no SDP, D2) to the UE-2 192 (block 210). UE-2 192 responds by transmitting to IMS CN 193 200 OK (O1, D2) (block 211), which in turn transmits 200 OK (O1, D2) to SCC AS 194 (block 212).

The SCC AS 194 transmits a re-INVITE (O2, D1b) to IMS CN 193 (block 213), which in turn transmits re-INVITE (O2, D1b) to UE-remote 195 (block 214). The UE-remote 195 responds by transmitting 200 OK (A2, D1b) to the IMS CN 193 (block 215), which in turn transmits 200 OK (A2, D1b) to SCC AS 194 (block 216). The SCC AS 194 transmits ACK (A1, D2) to the IMS CN 193 (block 217), which in turn transmits 200 OK (O2, D1b) to the SCC AS 194 (block 218). The SCC AS 194 transmits ACK (A1, D2) to IMS CN 193 (block 219). The IMS CN 193 relays this ACK (A1, D2) to UE-2 192 (block 220).

The controller leg update 198 can be required when media of UE-1 191 is affected. To that end, the SCC AS 194 transmits re-INVITE (O3, D1a) to the IMS CN 193 (block 221), which in turn transmits re-INVITE (O3, D1a) to UE-1 191 (block 222). UE-1 191 responds by transmitting 200 OK (A3, D1a) to the IMS CN 193 (block 223), which in turn transmits 200 OK (A3, D1a) to the SCC AS 194 (block 224). The SCC AS 194 transmits ACK (D1a) to the IMS CN 193 (block 225), which in turn transmits ACK (D1a) to the UE-1 191 (block 226).

With regard to IUT result notification 199, SCC AS 194 transmits NOTIFY (200 OK, Dx) to the IMS CN 193 (block 227), which in turn transmits NOTIFY (200 OK, Dx) to UE-1 191 (block 228). UE-1 191 responds by transmitting 200 OK (Dx) to IMS CN 193 (block 229), which in turn transmits 200 OK (Dx) to SCC AS 194 (block 230).

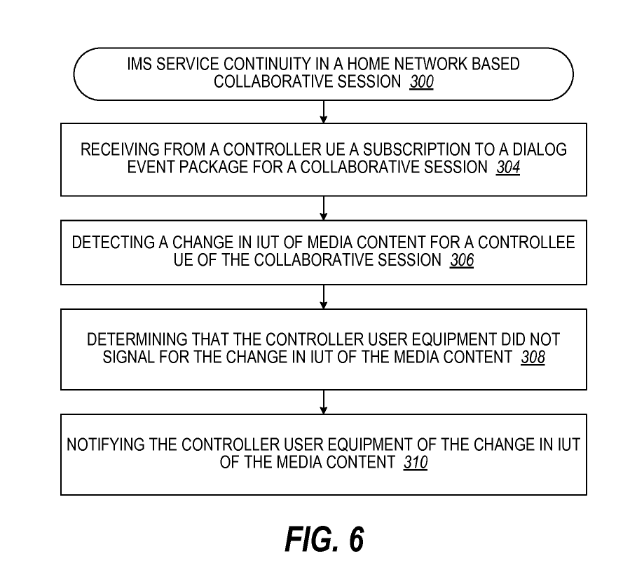

By virtue of the foregoing, in FIG. 6 a methodology or sequence of operations 300 is provided for IMS service continuity in a home network based collaborative session. A network apparatus such as an SCC AS receives from a controller UE a subscription to a dialog event package for a collaborative session (block 304). The SCC AS detects a change in IUT of media content for a controllee UE of the collaborative session (block 306). The SCC AS determines that the controller UE did not signal for the change in IUT of the media content (block 308). The SCC AS notifies the controller UE of the change in IUT of the media content (block 310).

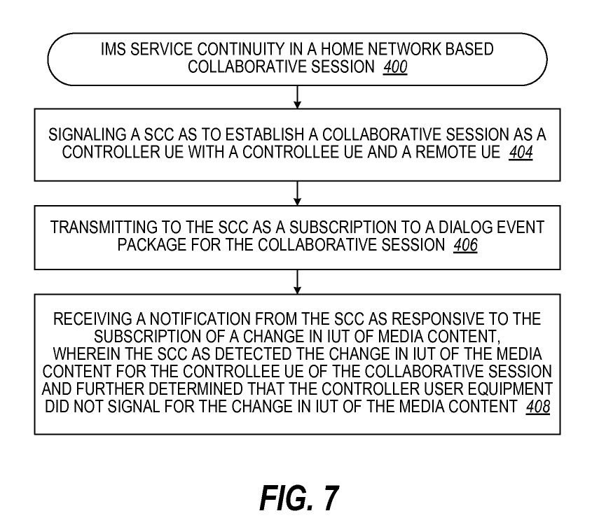

In FIG. 7, a methodology or sequence of operations 400 is provided for IMS service continuity in a home network based collaborative session. A controller UE signals a SCC AS to establish a collaborative session as a controller UE with a controllee UE and a remote UE (block 404). The controller UE transmits to the SCC AS a subscription to a dialog event package for the collaborative session (block 406). The controller UE receives a notification from the SCC AS responsive to the subscription of a change in IUT of media content, wherein the SCC AS detected the change in IUT of the media content for the controllee UE of the collaborative session and further determined that the controller UE did not signal for the change in IUT of the media content (block 408).

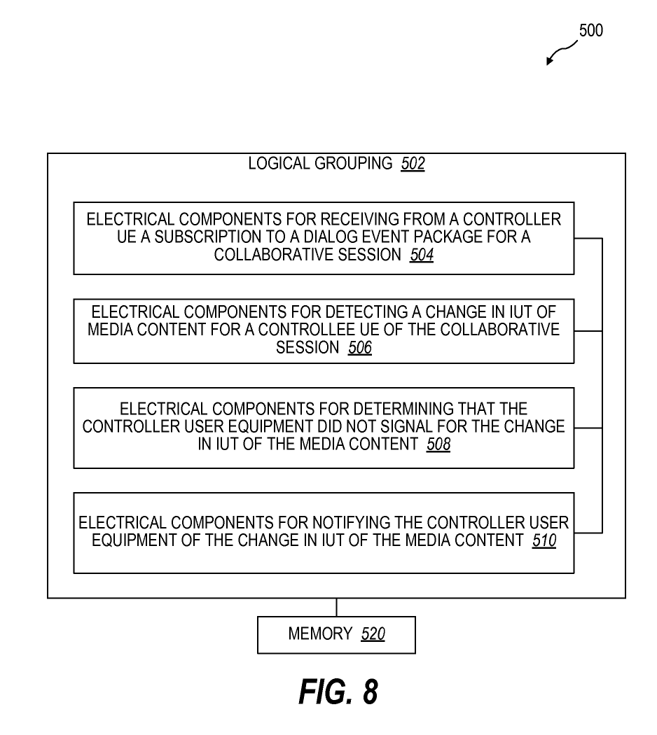

With reference to FIG. 8, illustrated is a system 500 for IMS service continuity in a home network based collaborative session. For example, system 500 can reside at least partially within user equipment (UE). It is to be appreciated that system 500 is represented as including functional blocks, which can be functional blocks that represent functions implemented by a computing platform, processor, software, or combination thereof (e.g., firmware). System 500 includes a logical grouping 502 of electrical components that can act in conjunction. For instance, logical grouping 502 can include an electrical component for receiving from a controller UE a subscription to a dialog event package for a collaborative session 504. Moreover, logical grouping 502 can include an electrical component for detecting a change in IUT of media content for a controllee UE of the collaborative session 506. Furthermore, logical grouping 502 can include an electrical component for determining that the controller UE did not signal for the change in IUT of the media content 508. In addition, logical grouping 502 can include an electrical component for notifying the controller UE of the change in IUT of the media content 510. Additionally, system 500 can include a memory 520 that retains instructions for executing functions associated with electrical components 504-510. While shown as being external to memory 520, it is to be understood that one or more of electrical components 504-510 can exist within memory 520.

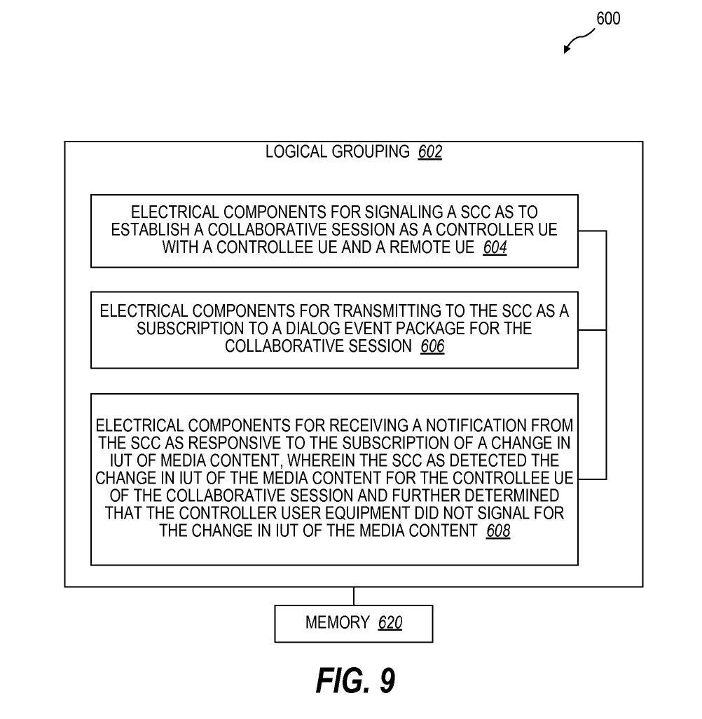

With reference to FIG. 9, illustrated is a system 600 for IMS service continuity in a home network based collaborative session. For example, system 600 can reside at least partially within a network entity (e.g., SCC AS). It is to be appreciated that system 600 is represented as including functional blocks, which can be functional blocks that represent functions implemented by a computing platform, processor, software, or combination thereof (e.g., firmware). System 600 includes a logical grouping 602 of electrical components that can act in conjunction. For instance, logical grouping 602 can include an electrical component for signaling a SCC AS to establish a collaborative session as a controller UE with a controllee UE and a remote UE 604. Moreover, logical grouping 602 can include an electrical component for transmitting to the SCC AS a subscription to a dialog event package for the collaborative session 606. In addition, logical grouping 602 can include an electrical component for receiving a notification from the SCC AS responsive to the subscription of a change in IUT of media content, wherein the SCC AS detected the change in IUT of the media content for the controllee UE of the collaborative session and further determined that the controller UE did not signal for the change in IUT of the media content 608. Additionally, system 600 can include a memory 620 that retains instructions for executing functions associated with electrical components 604-608. While shown as being external to memory 620, it is to be understood that one or more of electrical components 604-608 can exist within memory 620.

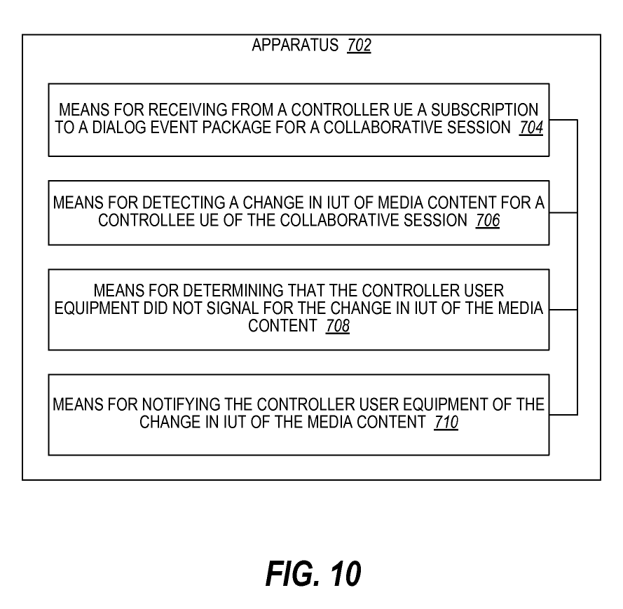

In FIG. 10, an apparatus 702 is depicted for IMS service continuity in a home network based collaborative session. Means 704 are provided for receiving from a controller UE a subscription to a dialog event package for a collaborative session. Means 706 are provided for detecting a change in IUT of media content for a controllee UE of the collaborative session. Means 708 are provided for determining that the controller UE did not signal for the change in IUT of the media content. Means 710 are provided for notifying the controller UE of the change in IUT of the media content.

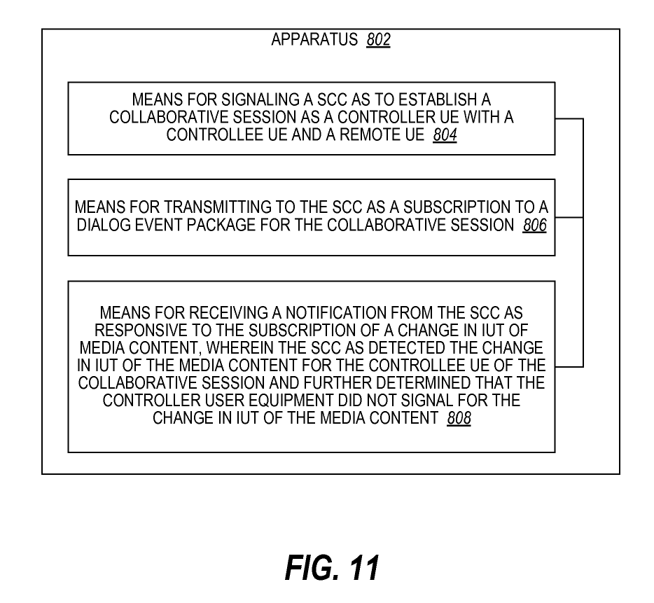

In FIG. 11, an apparatus 802 is depicted for IMS service continuity in a home network based collaborative session. Means 804 are provided for signaling a SCC AS to establish a collaborative session as a controller UE with a controllee UE and a remote UE. Means 806 are provided for transmitting to the SCC AS a subscription to a dialog event package for the collaborative session. Means 808 are provided for receiving a notification from the SCC AS responsive to the subscription of a change in IUT of media content, wherein the SCC AS detected the change in IUT of the media content for the controllee UE of the collaborative session and further determined that the controller UE did not signal for the change in IUT of the media content.

For clarity, the subscription and notification has been described as being between a controller UE and SCC AS. It should be appreciated with the benefit of the present disclosure that aspects of the present innovation can entail subscription by a controllee UE to receive notifications of changes in IUT. Thus, the SCC AS can determine that the subscribing controllee UE was not involved in the change in IUT of media content (i.e., the content changed at the controller UE or another controllee UE).

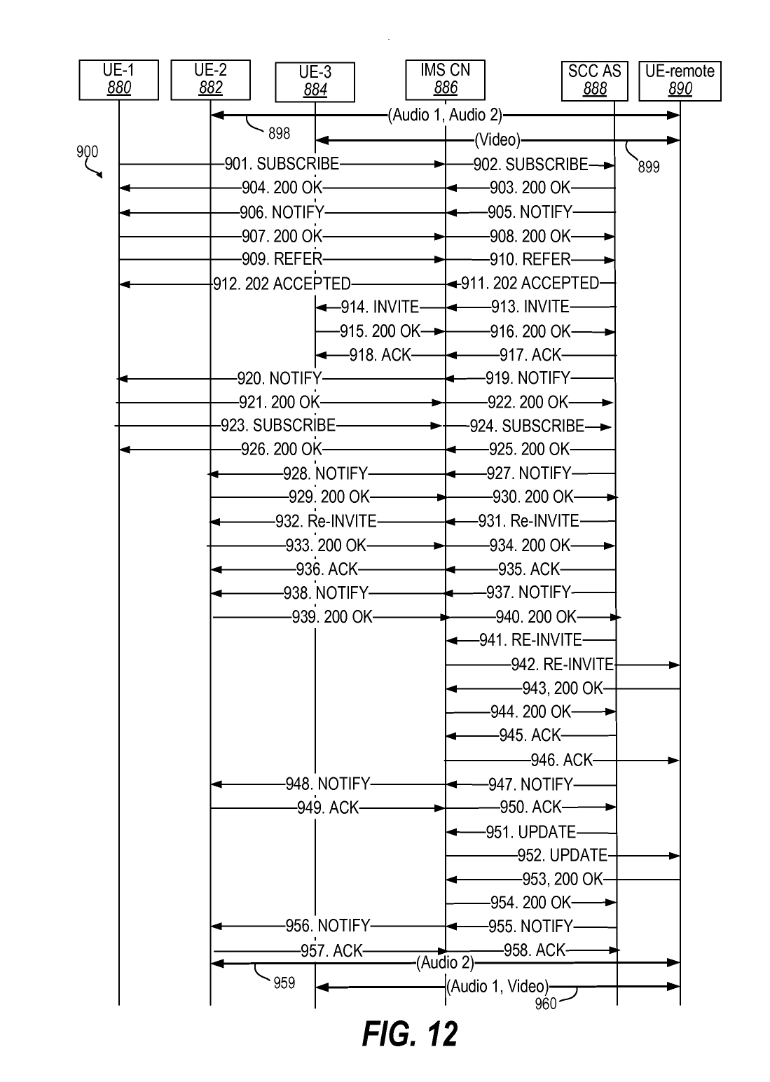

In FIG. 12, an exemplary call flow diagram 900 depicts the controller UE initiated media transfer from controllee UE to another controllee UE. In particular, the participants are depicted as UE-1 (controller) 880, UE-2 (controllee) 882, and UE-3 (controllee) 884, an IMS CN 886, a SCC AS 888, and a UE-remote 890. There is an existing session with audio 1 and audio 2 between UE-2 (123.45.67.89) 882, and remote UE (132.54.76.98) 890, depicted at 898. The video component is unidirectional from the remote UE 890 to the controllee UE, UE-3 (123.112.67.87) 884, depicted at 899.

The Controller UE 880 attempts to transfer audio 1 portion of this session to the controllee UE, UE-3, depicted as SUBSCRIBE sent to IMS CN 886 (block 901) that is relayed to SCC AS 888 (block 902). In TABLE 24, an exemplary SIP REFER request (UE-1 to SCC-AS) is described:

TABLE 24
REFER sip:scc-as@home1.net SIP/2.0
Via:
To: sip:scc-as@home1.net; tag= 24680
From: sip:user1_pubic1@home1.net; tag=13579
Call-ID: cb03a0s09a2sdfglkj490333
CSeq: 93809824 REFER
Max-Forwards: 70
P-Preferred-Identity:
Refer-To: <sip:user1_public3@home1.net;gr=urn:uuid:f81d4fae-
7dec-11d0-a765-00a0c91e6bf6body=m%3Daudio%200%20RTP%
2FAVP%200%0Dm%3Daudio%2049174%20RTP%2FAVP%2096%
0Dm%3Dvideo%201009%20RTP%2FAVP%2098%2099>
Require: target-dialog
Target-dialog: cb03a0s09a2sdfglkj321576;remote-tag=abcdef;local-
tag=123456
Contact: <sip:user1_pubic1@home1.net;gr=urn:uuid:f81d4fae-
7dec-11d0-a765-00a0c91ewxyz>
Accept: application/sdp, message/sipfrag
Content-Length: 0

SIP 202 (Accepted) response is sent from SCC AS 888 to UE-1 880 via IMS CN 888 as a response to SIP REFER request (blocks 903, 904, respectively). SCC-AS 888 sends SIP NOTIFY request to UE-1 880 to notify implicit subscription to the SIP REFER request results (blocks 905, 906, respectively).

TABLE 25 describes an exemplary SIP NOTIFY request from SCC-AS to UE-1:

TABLE 25

NOTIFY
Via:
To: sip:user1_pubic1@home1.net;tag=24680
From: sip:scc-as@home1.net;tag=13579
Call-ID:
CSeq:
Max-Forwards:
P-Asserted-Identity:
Require:
Contact: sip: scc-as@home1.net
Allow:
Event: refer
Subscription-State: active;expires=3600
Content-Type: message/sipfrag;version=2.0
Content-Length: (...)
SIP/2.0 100 Trying

The controller UE, UE-1, 880 acknowledges the SIP NOTIFY request by sending SIP 200 (OK) response to SCC-AS via IMS CN 886 (blocks 907, 908, respectively).

The controller UE-1 880 sends a SIP INVITE request to the SCC AS 888 via IMS CN 886 intended for UE-3 884 (blocks 909, 910, respectively). Since the message of blocks 1-2 contains a Refer-to header addressed to UE-3 884 and the URI parameters, listing an audio line which is not currently supported by another controllee UE than UE-3 884, the SCC AS 888 realizes the procedures is for transferring the media from that controllee UE (UE-2) 882 to controllee UE (UE-3) 884. The SCC AS 888 acknowledges the SIP INVITE request by sending SIP 200 (OK) response to controller UE-1 880 via IMS CN 886 (blocks 911, 912, respectively).

SCC-AS 888 sends SIP INVITE request to the controllee UE, UE-3, 884 via IMS CN 886 to transfer the audio media component (blocks 913, 914, respectively). The SDP in the INVITE lists are the media lines within the collaborative session. In order to avoid UE-3 884 starting to send audio to the remote UE 890, the SCC-AS 888 adds an a-line to inactive in the SDP offer.

TABLE 26 describes an exemplary SIP INVITE request (SCC-AS to UE-3):

TABLE 26
INVITE sip:user1_public3@home1.net;gr=urn:uuid:f81d4fae-7dec-
11d0-a765-00a0c91e6bf6 SIP/2.0
Via:
To: sip:user1_pubic3@home1.net;
From: sip:scc-as@home1.net; tag=12486
Call-ID:
CSeq:
Max-Forwards:
P-Asserted-Identity:
Require:
Contact:
Allow:
Content-Type: application/sdp
Content-Length: (...)
v=0
o=- 1027933615 1027933615 IN IP4 132.54.76.98
s=-
c=IN IP4 132.54.76.98
t=0 0
m=audio 49174 RTP/AVP 96 97
a=rtpmap:0 PCMU/8000
a=inactive
m=audio 0 RTP/AVP 0
m=video 1009 RTP/AVP 98 99
a=sendonly
b=AS:75
a=rtpmap:98 H263
a=fmtp:98 profile-level-id=0
a=rtpmap:99 MP4V-ES

Controllee UE-3 884 acknowledges the SIP INVITE request by sending SIP 200 (OK) response to SCC-AS 888 via IMS CN 886 (blocks 915, 916, respectively). TABLE 27 describes an exemplary SIP 200 OK response (UE-3 to SCC-AS):

TABLE 27

SIP/2.0 200 OK
Via:
To: sip:user1_pubic3@home1.net; tag = xyzwv
From: sip:scc-as@home1.net; tag = 12486
Call-ID:
CSeq:
P-Preferred-Identity:
Contact: sip:user1_pubic3@home1.net;gr=urn:uuid:f81d4fae-7dec-
11d0-a765-00a0c91e6bf6
Allow:
Content-Type: application/sdp
Content-Length: (...)
v=0
o=- 1027933615 1027933615 IN IP4 123.112.67.87
s=-
c=123.112.67.87
t=0 0
m=audio 3002 RTP/AVP 96 97
a=rtpmap:0 PCMU/8000
a=inactive
m=audio 0 RTP/AVP 0
m=video 1302 RTP/AVP 98 99
a=recvonly
b=AS:75
a=rtpmap:98 H263
a=fmtp:98 profile-level-id=0
a=rtpmap:99 MP4V-ES

SCC-AS 888 sends SIP ACK request to UE-3 884 via IMS CN 886 (blocks 917, 918, respectively).

SCC-AS 888 sends SIP NOTIFY request to controller UE, UE-1 880 via IMS CN 886 to inform about the success status of the transfer of Audio 1 to controllee UE-3 884 (blocks 919, 920, respectively).

TABLE 28 describes an exemplary SIP NOTIFY request (SCC-AS to UE-1):

TABLE 28

NOTIFY
Via:
To: sip:user1_pubic1@home1.net; tag=13579
From: sip:scc-as@home1.net; tag=24680
Call-ID:
CSeq:
Max-Forwards:
P-Asserted-Identity:
Require:
Contact: sip: scc-as@home1.net
Allow:
Event: refer
Subscription-State:terminated; reason=noresource
Content-Type: message/sipfrag ;version=2.0
Content-Length: (...)
SIP/2.0 200 OK
Content-Type:application/sdp
m=audio 3002 RTP/AVP 96 97
a=rtpmap:0 PCMU/8000
a=inactive
m=audio 0 RTP/AVP 0
m=video 1302 RTP/AVP 98 99
a=recvonly
c=123.112.67.87
b=AS:75
a=rtpmap:98 H263
a=fmtp:98 profile-level-id=0
a=rtpmap:99 MP4V-ES

The controller UE-1 acknowledges the SIP NOTIFY request by sending SIP 200 (OK) response to SCC-AS 888 via IMS CN 886 (blocks 921, 922, respectively).

Controller UE 880 sends SUBCRIBE request to SCC AS 888 via IMS CN 886 to subscribe to the existing dialog between the controller UE-1 880 and the SCC AS 888 (blocks 923, 924, respectively).

TABLE 29

SUBSCRIBE sip:scc-as@home1.net SIP/2.0
Via:
To: sip:scc-as@home1.net; tag= 24680
From: sip:user1_pubic1@home1.net; tag=13579
Call-ID: cb03a0s09a2sdfglkj490333
CSeq: 1 SUBSCRIBE
Max-Forwards: 70
P-Preferred-Identity:
Require: target-dialog
Target-dialog: cb03a0s09a2sdfglkj321576;remote-tag=abcdef;local-
tag=123456
Contact: sip:user1_pubic1@home1.net;gr=urn:uuid:f81d4fae-7dec-
11d0-a765-00a0c91ewxyz
CSeq:
Allow:
Accept: application/dialog-info+xml
Content-Type: application/sdp, message/sipfrag ;version=2.0
Content-Length: 0

The SCC AS 888 acknowledges the SIP SUBSCRIBE request by sending SIP 200 (OK) response to controller UE-1 880 via IMS CN 886 (blocks 925, 926, respectively).

The SCC AS 888 sends SIP NOTIFY request containing SDP for controllee UE-2, controllee UE-3, and the remote UE to controllee UE-2 882 via IMS CN 886 (blocks 927, 928, respectively).

```
TABLE 30
NOTIFY sip:user1_pubic1@home1.net;
Via:
To: sip:user1_pubic1@home1.net; tag=13579
From: sip:scc-as@home1.net; tag= 24680
Call-ID:
CSeq:
Max-Forwards:
P-Asserted-Identity:
Require:
Contact: sip: scc-as@home1.net
Allow:
Accept: application/dialog-info+xml
Content-Type: application/sdp, message/sipfrag ;version=2.0 ;
application/dialog-info+xml
Content-Length: (...)
<?xml version=“1.0” encoding=“UTF-8”?>
<xs:schema xmlns:xs=“http://www.w3.org/2001/XMLSchema”
elementFormDefault=“qualified”
                  attributeFormDefault=“unqualified” version=“1”>
<xs:element name=“session-description” type=“tns:sessd”
      minOccurs=“0” maxOccurs=“1”/>
<xs:complexType name=“sessd”>
    <xs:simpleContent>
    <xs:extension base=“xs:string”>
      <xs:attribute name=“type” type=“xs:string”
              use=“required”/>
m=audio 75875 RTP/AVP
c=IN IP4 123.112.67.87
m=audio 34002 RTP/AVP 96 97
c=IN IP4 123.112.67.87
a=rtpmap:0 PCMU/8000
m=video 0 RTP/AVP 0
m=audio 3002 RTP/AVP 96 97
c=123.112.67.87
a=rtpmap:0 PCMU/8000
a=inactive
m=audio 0 RTP/AVP 0
c=123.112.67.87
m=video 1302 RTP/AVP 98 99
c=123.112.67.87
a=recvonly
b=AS:75
a=rtpmap:98 H263
a=fmtp:98 profile-level-id=0
a=rtpmap:99 MP4V-ES
m=audio 49174 RTP/AVP 96 97
c= IN IP4 132.54.76.98
b=AS:25.4
a=rtpmap:96 AMR
a=fmtp:96mode-set=0,2,5,7; mode-change-period=2
a=rtpmap:97 telephone-event
a=maxptime:20
m=audio 44552 RTP/AVP 96 97
c= IN IP4 132.54.76.98
a=rtpmap:0 PCMU/8000
m=video 1009 RTP/AVP 98 99
c= IN IP4 132.54.76.98
a=sendonly
b=AS:75
a=rtpmap:98 H263
a=fmtp:98 H263
a=fmtp:98 profile-level-id=0
a=rtpmap:99 MP4V-ES
    </xs:extension>
    </xs:simpleContent>
    </xs:complexType>
</xs:schema>
```

The controllee UE-2 882 acknowledges the SIP NOTIFY request by sending SIP 200 (OK) response to SCC AS 888 via IMS CN 886 (blocks 929, 930, respectively).

The SCC AS 888 sends a re-INVITE to UE-2 882 via IMS CN 886 to terminate Audio 1 (blocks 931, 932, respectively).

TABLE 31 describes a SIP INVITE request (SCC-AS to UE-2):

TABLE 31
INVITE sip:user1_public2@home3.net;gr=urn:uuid:f81d4fae-7dec-
11d0-a765-00a0c91e6bf6 SIP/2.0
Via:
To: sip:user1_pubic2@home1.net;
From: sip:scc-as@home1.net; tag=12386
Call-ID:
CSeq:
Max-Forwards:
P-Asserted-Identity:
Require:
Contact:
Allow:
Content-Type: application/sdp
Content-Length: (...)
v=0
0=- 1027933615 1027933615 IN IP4 123.112.67.87
s=-
c=IN IP4 123.112.67.87
t=0 0
m=audio 0 RTP/AVP 0
m=audio 44552 RTP/AVP 96 97
a=rtpmap:0 PCMU/8000

The controllee UE, UE-2, 882 acknowledges the SIP INVITE request by sending SIP 200 (OK) response to SCC-AS 888 via IMS CN 886 (blocks 933, 934, respectively).

TABLE 32 describes an exemplary SIP 200 OK response (UE-2 to SCC-AS):

TABLE 32

SIP/2.0 200 OK
Via:
To: sip:user1_pubic2@home1.net; tag = xyzwv
From: sip:scc-as@home1.net; tag = 12486
Call-ID:
CSeq:
P-Preferred-Identity:
Contact: sip:user1_pubic2@home1.net;gr=urn:uuid:f81d4fae-7dec-
11d0-a765-00a0c91e6bf6
Allow:
Content-Type: application/sdp
Content-Length: (...)
v=0
0=- 1027933615 1027933615 IN IP4 123.45.67.89
s=-
c=IN IP4 123.45.67.89
t=0 0
m=audio 0 RTP/AVP 0
m=audio 34002 RTP/AVP 96 97
a=rtpmap:0 PCMU/8000

SCC-AS 888 sends ACK to UE-2 882 via IMS CN 886 to acknowledge (blocks 935, 936, respectively).

The SCC AS 888 sends SIP NOTIFY request containing SDP for controllee UE-2, controllee UE-3, and the remote UE to the controller UE-2 via IMS CN 886 (blocks 937, 938, respectively).

TABLE 33

```
NOTIFY sip:user1_pubic1@home1.net;
Via:
To: sip:user1_pubic1@home1.net; tag=13579
From: sip:scc-as@home1.net; tag= 24680
Call-ID:
CSeq:
Max-Forwards:
P-Asserted-Identity:
Require:
Contact: sip: scc-as@home1.net
Allow:
Accept: application/dialog-info+xml
Content-Type: application/sdp, message/sipfrag ;version=2.0 ;
application/dialog-info+xml
Content-Length: (...)
<xs:element name=“session-description” type=“tns:sessd”
      minOccurs=“0” maxOccurs=“1”/>
<xs:complexType name=“sessd”>
    <xs:simpleContent>
    <xs:extension base=“xs:string”>
      <xs:attribute name=“type” type=“xs:string”
                use=“required”/>
m=audio 0 RTP/AVP 0
c=IN IP4 123.112.67.87
m=audio 34002 RTP/AVP 96 97
c=IN IP4 123.112.67.87
a=rtpmap:0 PCMU/8000
m=video 0 RTP/AVP 0
m=audio 3002 RTP/AVP 96 97
c=123.112.67.87
a=rtpmap:0 PCMU/8000
a=inactive
m=audio 0 RTP/AVP 0
c=123.112.67.87
m=video 1302 RTP/AVP 98 99
c=123.112.67.87
a=recvonly
b=AS:75
a=rtpmap:98 H263
a=fmtp:98 profile-level-id=0
a=rtpmap:99 MP4V-ES
m=audio 49174 RTP/AVP 96 97
c= IN IP4 132.54.76.98
b=AS:25.4
a=rtpmap:96 AMR
a=fmtp:96mode-set=0,2,5,7; mode-change-period=2
a=rtpmap:97 telephone-event
a=maxptime:20
m=audio 44552 RTP/AVP 96 97
c= IN IP4 132.54.76.98
a=rtpmap:0 PCMU/8000
m=video 1009 RTP/AVP 98 99
c= IN IP4 132.54.76.98
a=sendonly
b=AS:75
a=rtpmap:98 H263
a=fmtp:98 H263
a=fmtp:98 profile-level-id=0
a=rtpmap:99 MP4V-ES
    </xs:extension>
    </xs:simpleContent>
    </xs:complexType>
```

The controllee UE-2 882 acknowledges the SIP NOTIFY request by sending SIP 200 (OK) response to SCC AS 888 via IMS CN 886 (blocks 939, 940, respectively).

SCC-AS 888 sends SIP re-INVITE request to the remote UE 890 via IMS CN 886 (blocks 941, 942, respectively).

TABLE 34 describes an exemplary SIP INVITE request (SCC-AS to remote UE):

TABLE 34
INVITE sip:user2_public1@home3.net;SIP/2.0
Via:
To: sip:user2_pubic1@home2.net;tag=66666
From: sip:scc-as@home1.net; tag=33333
Call-ID:
CSeq:
Max-Forwards:
P-Asserted-Identity:
Require:
Contact: sip:user1_public1@home1.net; gr=urn:uuid:f81d4fae-7dec-
11d0-a765-00a0c91ewxyz
Allow:
Content-Type: application/sdp
Content-Length: (...)
v=0
0=- 1027933615 1027933615 IN IP4 123.112.67.87
s=-
t=0 0
m=audio 3002 RTP/AVP 96 97
c= IN IP4 123.112.67.87
a=rtpmap:0 PCMU/8000
m=audio 34002 RTP/AVP 96 97
C=IN IP4 123.45.67.89
A=rtpmap:0 PCMU/8000
m=video 1302 RTP/AVP 98 99
c= IN IP4 123.112.67.87
b=AS:75
a=rtpmap:98 H263
a=fmtp:98 profile-level-id=0
a=rtpmap:99 MP4V-ES

The remote UE 890 acknowledges the SIP re-INVITE request by sending SIP 200 (OK) response to SCC-AS 888 via IMS CN 886 (blocks 943, 944, respectively).

TABLE 35 describes an exemplary SIP 200 (OK) response (remote UE to SCC-AS):

TABLE 35

SIP/2.0 200 OK
Via:
To:
From:
Call-ID:
CSeq:
P-Asserted-Identity:
Contact: sip:user2_pubic1@home2.net;
Allow:
Content-Type: application/sdp
Content-Length: (...)
v=0
o=- 1027933615 1027933615 IN IP4 132.54.76.98
s=-
c= IN IP4 132.54.76.98
t=0 0
m=audio 49174 RTP/AVP 96 97
b=AS:25.4
a=rtpmap:96 AMR
a=fmtp:96mode-set=0,2,5,7; mode-change-period=2
a=rtpmap:97 telephone-event
a=maxptime:20
m=audio 44552 RTP/AVP 96 97
a=rtpmap:0 PCMU/8000
m=video 1009 RTP/AVP 98 99
a=sendonly
b=AS:75
a=rtpmap:98 H263
a=fmtp:98 H263
a=fmtp:98 profile-level-id=0
a=rtpmap:99 MP4V-ES

SCC-AS 888 sends SIP ACK request to the remote UE 890 via IMS CN 886 (blocks 945, 946, respectively).

The SCC AS 888 sends SIP NOTIFY request containing SDP for controllee UE-2 882, controllee UE-3 884, and the remote UE 890 (blocks 947, 948, respectively).

TABLE 36

```
NOTIFY sip:user1_pubic1@home1.net;
Via:
To: sip:user1_pubic1@home1.net; tag=13579
From: sip:scc-as@home1.net; tag= 24680
Call-ID:
CSeq:
Max-Forwards:
P-Asserted-Identity:
Require:
Contact: sip: scc-as@home1.net
Allow:
Accept: application/dialog-info+xml
Content-Type: application/sdp, message/sipfrag ;version=2.0 ;
application/dialog-info+xml
Content-Length: (...)
<xs:element name=“session-description” type=“tns:sessd”
      minOccurs=“0” maxOccurs=“1”/>
<xs:complexType name=“sessd”>
    <xs:simpleContent>
    <xs:extension base=“xs:string”>
      <xs:attribute name=“type” type=“xs:string”
              use=“required”/>
m=audio 75875 RTP/AVP
c=IN IP4 123.112.67.87
m=audio 34002 RTP/AVP 96 97
c=IN IP4 123.112.67.87
a=rtpmap:0 PCMU/8000
m=video 0 RTP/AVP 0
m=audio 3002 RTP/AVP 96 97
c=123.112.67.87
a=rtpmap:0 PCMU/8000
a=inactive
m=audio 0 RTP/AVP 0
c=123.112.67.87
m=video 1302 RTP/AVP 98 99
c=123.112.67.87
a=recvonly
b=AS:75
a=rtpmap:98 H263
a=fmtp:98 profile-level-id=0
a=rtpmap:99 MP4V-ES
m=audio 49174 RTP/AVP 96 97
c= IN IP4 132.54.76.98
b=AS:25.4
a=rtpmap:96 AMR
a=fmtp:96mode-set=0,2,5,7; mode-change-period=2
a=rtpmap:97 telephone-event
a=maxptime:20
m=audio 44552 RTP/AVP 96 97
c= IN IP4 132.54.76.98
a=rtpmap:0 PCMU/8000
m=video 1009 RTP/AVP 98 99
c= IN IP4 132.54.76.98
a=sendonly
b=AS:75
a=rtpmap:98 H263
a=fmtp:98 H263
a=fmtp:98 profile-level-id=0
a=rtpmap:99 MP4V-ES
      </xs:extension>
    </xs:simpleContent>
    </xs:complexType>
```

The controllee UE-2 882 acknowledges the SIP NOTIFY request by sending SIP 200 (OK) response to SCC AS 888 via IMS CN 886 (blocks 949, 950, respectively).

SCC-AS 888 sends SIP UPDATE request to UE-3 890 via IMS CN 886 to activate the audio 1 media component (blocks 951, 952, respectively).

TABLE 37
UPDATE sip:user1_public3@home1.net;gr=urn:uuid:f81d4fae-7dec-
11d0-a765-00a0c91e6bf6 SIP/2.0
Via:
To: sip:user1_pubic3@home1.net;
From: sip:scc-as@home1.net; tag=12486
Call-ID:
CSeq:
Max-Forwards:
P-Asserted-Identity:
Require:
Contact:
Allow:
Content-Type: application/sdp
Content-Length: (...)
v=0
0=- 1027933615 1027933615 IN IP4 123.112.67.87
s=-
c=IN IP4 123.112.67.87
t=0 0
m=audio 49174 RTP/AVP 96 97
a=rtpmap:0 PCMU/8000
a=active
m=audio 0 RTP/AVP 0
m=video 1009 RTP/AVP 98 99
b=AS:75
a=rtpmap:98 H263
a=fmtp:98 profile-level-id=0
a=rtpmap:99 MP4V-ES

Controllee UE, UE-3 884 sends SIP 200 (OK) response to SCC AS 888 via IMS CN 886 (blocks 953, 954, respectively).

The SCC AS 888 sends SIP NOTIFY request containing SDP for controllee UE-2 882, controllee UE-3 884, and the remote UE 890 (blocks 955, 956, respectively).

TABLE 38

```
NOTIFY sip:user1_pubic1@home1.net;
Via:
To: sip:user1_pubic1@home1.net; tag=13579
From: sip:scc-as@home1.net; tag= 24680
Call-ID:
CSeq:
Max-Forwards:
P-Asserted-Identity:
Require:
Contact: sip: scc-as@home1.net
Allow:
Accept: application/dialog-info+xml
Content-Type: application/sdp, message/sipfrag ;version=2.0 ;
application/dialog-info+xml
Content-Length: (...)
<xs:element name=“session-description” type=“tns:sessd”
      minOccurs=“0” maxOccurs=“1”/>
<xs:complexType name=“sessd”>
    <xs:simpleContent>
    <xs:extension base=“xs:string”>
      <xs:attribute name=“type” type=“xs:string”
                use=“required”/>
m=audio 75875 RTP/AVP
c=IN IP4 123.112.67.87
m=audio 34002 RTP/AVP 96 97
c=IN IP4 123.112.67.87
a=rtpmap:0 PCMU/8000
m=video 0 RTP/AVP 0
m=audio 3002 RTP/AVP 96 97
c=123.112.67.87
a=rtpmap:0 PCMU/8000
a=active
m=audio 0 RTP/AVP 0
c=123.112.67.87
m=video 1302 RTP/AVP 98 99
c=123.112.67.87
a=recvonly
b=AS:75
a=rtpmap:98 H263
a=fmtp:98 profile-level-id=0
a=rtpmap:99 MP4V-ES
m=audio 49174 RTP/AVP 96 97
c= IN IP4 132.54.76.98
b=AS:25.4
a=rtpmap:96 AMR
a=fmtp:96mode-set=0,2,5,7; mode-change-period=2
a=rtpmap:97 telephone-event
a=maxptime:20
m=audio 44552 RTP/AVP 96 97
c= IN IP4 132.54.76.98
a=rtpmap:0 PCMU/8000
m=video 1009 RTP/AVP 98 99
c= IN IP4 132.54.76.98
a=sendonly
b=AS:75
a=rtpmap:98 H263
a=fmtp:98 H263
a=fmtp:98 profile-level-id=0
a=rtpmap:99 MP4V-ES
    </xs:extension>
    </xs:simpleContent>
    </xs:complexType>
```

The controllee UE-2 882 acknowledges the SIP NOTIFY request by sending SIP 200 (OK) response to SCC AS 888 via IMS CN 886 (blocks 957, 958, respectively).

Thereby, there is a session with audio 2 between UE-2 (123.45.67.89) 882, and remote UE (132.54.76.98) 890, depicted at 959. The video component is unidirectional from the remote UE 890 to the controllee UE, UE-3 (123.112.67.87) 884, with a bi-directional audio 1 as depicted at 960.

Those of skill would further appreciate that the various illustrative logical blocks, modules, circuits, and algorithm steps described in connection with the aspects disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

As used in this application, the terms “component”, “module”, “system”, and the like are intended to refer to a computer-related entity, either hardware, a combination of hardware and software, software, or software in execution. For example, a component may be, but is not limited to being, a process running on a processor, a processor, an object, an executable, a thread of execution, a program, and/or a computer. By way of illustration, both an application running on a server and the server can be a component. One or more components may reside within a process and/or thread of execution and a component may be localized on one computer and/or distributed between two or more computers.

The word “exemplary” is used herein to mean serving as an example, instance, or illustration. Any aspect or design described herein as “exemplary” is not necessarily to be construed as preferred or advantageous over other aspects or designs.

Various aspects will be presented in terms of systems that may include a number of components, modules, and the like. It is to be understood and appreciated that the various systems may include additional components, modules, etc. and/or may not include all of the components, modules, etc. discussed in connection with the figures. A combination of these approaches may also be used. The various aspects disclosed herein can be performed on electrical devices including devices that utilize touch screen display technologies and/or mouse-and-keyboard type interfaces. Examples of such devices include computers (desktop and mobile), smart phones, personal digital assistants (PDAs), and other electronic devices both wired and wireless.

In addition, the various illustrative logical blocks, modules, and circuits described in connection with the aspects disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

Furthermore, the one or more versions may be implemented as a method, apparatus, or article of manufacture using standard programming and/or engineering techniques to produce software, firmware, hardware, or any combination thereof to control a computer to implement the disclosed aspects. The term “article of manufacture” (or alternatively, “computer program product”) as used herein is intended to encompass a computer program accessible from any computer-readable device, carrier, or media. For example, computer readable media can include but are not limited to magnetic storage devices (e.g., hard disk, floppy disk, magnetic strips . . . ), optical disks (e.g., compact disk (CD), digital versatile disk (DVD) . . . ), smart cards, and flash memory devices (e.g., card, stick). Additionally it should be appreciated that a carrier wave can be employed to carry computer-readable electronic data such as those used in transmitting and receiving electronic mail or in accessing a network such as the Internet or a local area network (LAN). Of course, those skilled in the art will recognize many modifications may be made to this configuration without departing from the scope of the disclosed aspects.

The steps of a method or algorithm described in connection with the aspects disclosed herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such the processor can read information from, and write information to, the storage medium. In the alternative, the storage medium may be integral to the processor. The processor and the storage medium may reside in an ASIC. The ASIC may reside in a user terminal. In the alternative, the processor and the storage medium may reside as discrete components in a user terminal.

The previous description of the disclosed aspects is provided to enable any person skilled in the art to make or use the present disclosure. Various modifications to these aspects will be readily apparent to those skilled in the art, and the generic principles defined herein may be applied to other embodiments without departing from the spirit or scope of the disclosure. Thus, the present disclosure is not intended to be limited to the embodiments shown herein but is to be accorded the widest scope consistent with the principles and novel features disclosed herein.

In view of the exemplary systems described supra, methodologies that may be implemented in accordance with the disclosed subject matter have been described with reference to several flow diagrams. While for purposes of simplicity of explanation, the methodologies are shown and described as a series of blocks, it is to be understood and appreciated that the claimed subject matter is not limited by the order of the blocks, as some blocks may occur in different orders and/or concurrently with other blocks from what is depicted and described herein. Moreover, not all illustrated blocks may be required to implement the methodologies described herein. Additionally, it should be further appreciated that the methodologies disclosed herein are capable of being stored on an article of manufacture to facilitate transporting and transferring such methodologies to computers. The term article of manufacture, as used herein, is intended to encompass a computer program accessible from any computer-readable device, carrier, or media.

It should be appreciated that any patent, publication, or other disclosure material, in whole or in part, that is said to be incorporated by reference herein is incorporated herein only to the extent that the incorporated material does not conflict with existing definitions, statements, or other disclosure material set forth in this disclosure. As such, and to the extent necessary, the disclosure as explicitly set forth herein supersedes any conflicting material incorporated herein by reference. Any material, or portion thereof, that is said to be incorporated by reference herein, but which conflicts with existing definitions, statements, or other disclosure material set forth herein, will only be incorporated to the extent that no conflict arises between that incorporated material and the existing disclosure material.

What is claimed is:

1. A method for Internet Protocol Multimedia Subsystem (IMS) service continuity in a home network based collaborative session, comprising:
receiving from a selected one of a controller User Equipment (UE) and a controllee UE a subscription to a dialog event package for a collaborative session that terminates at a remote UE;
detecting a change in Inter-UE Transfer (IUT) of media content for the collaborative session;
determining that the selected one of the controller UE and the controllee UE did not signal for the change in IUT of the media content; and
notifying the selected one of the controller UE and the controllee UE of the change in IUT of the media content.

2. The method of claim 1, wherein receiving the subscription to the dialog event package for the collaborative session further comprises receiving an explicit duration value for the subscription.

3. The method of claim 1, wherein receiving the subscription to the dialog event package for the collaborative session further comprises receiving the subscription to receive information about existing media components.

4. The method of claim 3, wherein receiving the subscription to receive information further comprises receiving the subscription to receive related information comprising a media property and port numbers in the collaborative session between the controller UE and the remote UE.

5. The method of claim 1, wherein the receiving the subscription from the controllee UE to the dialog event package for the collaborative session further comprising receiving the subscription for information about participation by the controller UE in the collaborative session.

6. The method of claim 5, wherein receiving the subscription for information about participation by the controller UE further comprises receiving the subscription for information about media components and related information comprising a media property and a port number belonging to the controller UE.

7. The method of claim 1, wherein the receiving the subscription from the controller UE to the dialog event package for the collaborative session further comprising receiving the subscription for information about participation by the controllee UE in the collaborative session.

8. The method of claim 7, wherein receiving the subscription for information about participation by the controllee UE further comprises receiving the subscription for information about media components and related information comprising a media property and a port number belonging to the controllee UE.

9. The method of claim 1, wherein detecting the change in IUT of media content further comprises communicating with the controllee UE to transfer the media content.

10. The method of claim 9, wherein communicating with the controllee UE to transfer the media content further comprising:
signaling the controllee UE for the transfer of the media content to be inactive;
notifying the remote UE and the controller UE of the change in IUT of the media content; and
signaling the controllee UE for the transfer of the media content to be active.

11. The method of claim 1, wherein detecting the change in IUT of media content further comprises:
maintaining respective dialogs with the controller UE, the controllee UE and the remote UE;
receiving a message containing a refer-to heading addressed to the collaborative session;
determining that a media line in the message references media content available from the controllee UE and not from the controller UE; and
sending a Session Initiation Protocol (SIP) invite request to the controllee UE to transfer the media content.

12. The method of claim 1, wherein notifying the selected one of the controller UE and the controllee UE of the change further comprises sending a Session Initiation Protocol (SIP) notify request constructed by having an XML body with a session description element containing a Session Description Protocol (SDP) of all of the controllee UEs and remote UEs, including media lines and related information.

13. The method of claim 1, further comprising sending a Session Initiation Protocol (SIP) request to the controller UE in response to determining that a change in inter-UE transfer (IUT) of media content requested by an initial SIP refer request by the controller UE has been fulfilled.

14. At least one processor for Internet Protocol Multimedia Subsystem (IMS) service continuity in a home network based collaborative session, comprising:
a first module for receiving from a selected one of a controller User Equipment (UE) and a controllee UE a subscription to a dialog event package for a collaborative session that terminates at a remote UE;
a second module for detecting a change in Inter-UE Transfer (IUT) of media content for the collaborative session;
a third module for determining that the selected one of the controller UE and the controllee UE did not signal for the change in IUT of the media content; and
a fourth module for notifying the selected one of the controller UE and the controllee UE of the change in IUT of the media content.

15. A computer program product for Internet Protocol Multimedia Subsystem (IMS) service continuity in a home network based collaborative session, comprising:
a non-transitory computer-readable medium for storing sets of code comprising:
a first set of codes for causing a computer to receive from a selected one of a controller User Equipment (UE) and a controllee UE a subscription to a dialog event package for a collaborative session that terminates at a remote UE;
a second set of codes for causing the computer to detect a change in Inter-UE Transfer (IUT) of media content for the collaborative session;
a third set of codes for causing the computer to determine that the selected one of the controller UE and the controllee UE did not signal for the change in IUT of the media content; and
a fourth set of codes for causing the computer to notify the selected one of the controller UE and the controllee UE of the change in IUT of the media content.

16. An apparatus for Internet Protocol Multimedia Subsystem (IMS) service continuity in a home network based collaborative session, comprising:
means for receiving from a selected one of a controller User Equipment (UE) and a controllee UE a subscription to a dialog event package for a collaborative session that terminates at a remote UE;
means for detecting a change in Inter-UE Transfer (IUT) of media content for the collaborative session;
means for determining that the selected one of the controller UE and the controllee UE did not signal for the change in IUT of the media content; and
means for notifying the selected one of the controller UE and the controllee UE of the change in IUT of the media content.

17. An apparatus for Internet Protocol Multimedia Subsystem (IMS) service continuity in a home network based collaborative session, comprising:
a network interface for receiving from a selected one of a controller User Equipment (UE) and a controllee UE a subscription to a dialog event package for a collaborative session that terminates at a remote UE;
a computing platform for detecting a change in Inter-UE Transfer (IUT) of media content for the collaborative session and for determining that the selected one of the controller UE and the controllee UE did not signal for the change in IUT of the media content; and
the network interface further for notifying the selected one of the controller UE and the controllee UE of the change in IUT of the media content.

18. The apparatus of claim 17, wherein the network interface is further for receiving the subscription to the dialog event package for the collaborative session by receiving an explicit duration value for the subscription.

19. The apparatus of claim 17, wherein the network interface is further for receiving the subscription to the dialog event package for the collaborative session by receiving the subscription to receive information about existing media components.

20. The apparatus of claim 19, wherein the network interface is further for receiving the subscription to receive information by receiving the subscription to receive related information comprising a media property and port numbers in the collaborative session between the controller UE and the remote UE.

21. The apparatus of claim 17, wherein the network interface is further for receiving the subscription from the controllee UE to the dialog event package for the collaborative session by receiving the subscription for information about participation by the controller UE in the collaborative session.

22. The apparatus of claim 21, wherein the network interface is further for receiving the subscription for information about participation by the controller UE by receiving the subscription for information about media components and related information comprising a media property and a port number belonging to the controller UE.

23. The apparatus of claim 17, wherein the network interface is further for receiving the subscription from the controller UE to the dialog event package for the collaborative session by receiving the subscription for information about participation by the controllee UE in the collaborative session.

24. The apparatus of claim 23, wherein the network interface is further for receiving the subscription for information about participation by the controllee UE by receiving the subscription for information about media components and related information comprising a media property and a port number belonging to the controllee UE.

25. The apparatus of claim 17, wherein the computing platform is further for detecting the change in IUT of media content by communicating with the controllee UE to transfer the media content.

26. The apparatus of claim 25, wherein the network interface is further for communicating with the controllee UE to transfer the media content by:
signaling the controllee UE for the media transfer to be inactive;
notifying the remote UE and the controller UE of the change in IUT of media content; and
signaling the controllee UE for the media transfer to be active.

27. The apparatus of claim 17, wherein the computing platform is further for detecting the change in IUT of media content by maintaining respective dialogs with the controller UE, the controllee UE and the remote UE;
the network interface is further for receiving a message containing a refer-to heading addressed to the collaborative session;
the computing platform is further for determining that a media line in the message references media content available from the controllee UE and not the controller UE; and
the network interface is further for sending a Session Initiation Protocol (SIP) invite request to the controllee UE to transfer the media content.

28. The apparatus of claim 17, wherein the network interface is further for notifying the selected one of the controller UE and the controllee UE of the change by sending a Session Initiation Protocol (SIP) notify request constructed by having an XML body with a session description element containing a Session Description Protocol (SDP) of all of the controllee UEs and remote UEs, including media lines and related information.

29. The apparatus of claim 17, wherein the network interface is further for sending a Session Initiation Protocol (SIP) request to the controller UE in response to determining that a change in inter-UE transfer (IUT) of media content requested by an initial SIP refer request by the controller UE has been fulfilled.

30. A method for Internet Protocol Multimedia Subsystem (IMS) service continuity in a home network based collaborative session, comprising:
signaling a Session Continuity Controller (SCC) Application Server (AS) for participating in a collaborative session terminating at a remote User Equipment (UE) as a selected one of a controller UE and a controllee UE;
transmitting to the SCC AS a subscription to a dialog event package for the collaborative session; and
receiving a notification from the SCC AS responsive to the subscription of a change in Inter-UE Transfer (IUT) of media content,
wherein the SCC AS detected the change in IUT of the media content for the collaborative session and further determined that the selected one of the controller UE and the controllee UE did not signal for the change in IUT of the media content.

31. The method of claim 30, wherein transmitting to the SCC AS the subscription to the dialog event package for the collaborative session further comprises transmitting an explicit duration value for the subscription.

32. The method of claim 30, wherein transmitting the subscription to the dialog event package for the collaborative session further comprises transmitting the subscription to receive information about existing media components.

33. The method of claim 32, wherein transmitting the subscription to receive information further comprises transmitting the subscription to receive related information comprising a media property and port numbers in the collaborative session between the controller UE and the remote UE.

34. The method of claim 30, wherein transmitting the subscription from the controllee UE to the dialog event package for the collaborative session further comprising transmitting the subscription for information about participation by the controller UE in the collaborative session.

35. The method of claim 34, wherein transmitting the subscription for information about participation by the controller UE further comprises transmitting the subscription for information about media components and related information comprising a media property and a port number belonging to the controller UE.

36. The method of claim 30, wherein the transmitting the subscription from the controller UE to the dialog event package for the collaborative session further comprising transmitting the subscription for information about participation by the controllee UE in the collaborative session.

37. The method of claim 36, wherein transmitting the subscription for information about participation by the controllee UE further comprises transmitting the subscription for information about media components and related information comprising a media property and a port number belonging to the controllee UE.

38. The method of claim 30, wherein the SCC AS detects the change in IUT of the media content by communicating with the controllee UE to transfer the media content.

39. The method of claim 38, wherein the SCC AS communicates with the controllee UE to transfer the media content by:
signaling the controllee UE for the transfer of medium content to be inactive;
notifying the remote UE and the controller UE of the change in IUT of the media content; and
signaling the controllee UE for the transfer of the medium content to be active.

40. The method of claim 30, wherein the SCC AS detects the change in IUT of media content by:
maintaining respective dialogs with the controller UE, the controllee UE and the remote UE;
receiving a message containing a refer-to heading addressed to the collaborative session;
determining that a media line in the message references media content available from the controllee UE and not the controller UE; and
sending a Session Initiation Protocol (SIP) invite request to the controllee UE to transfer the media content.

41. The method of claim 30, wherein receiving the notification from the SCC AS responsive to the subscription of the change in IUT of the media content further comprises receiving a Session Initiation Protocol (SIP) notify request constructed by having an XML body with a session description element containing a Session Description Protocol (SDP) of all of the controllee UEs and remote UEs, including media lines and related information.

42. The method of claim 30, further comprising receiving a Session Initiation Protocol (SIP) request at the controller UE in response to a determination by the SCC AS that a change in inter-UE transfer (IUT) of media content requested by an initial SIP refer request by the controller UE has been fulfilled.

43. At least one processor for Internet Protocol Multimedia Subsystem (IMS) service continuity in a home network based collaborative session, comprising:
a first module for signaling a Session Continuity Controller (SCC) Application Server (AS) for participating in a collaborative session terminating at a remote User Equipment (UE) as a selected one of a controller UE and a controllee UE;
a second module for transmitting to the SCC AS a subscription to a dialog event package for the collaborative session; and
a third module for receiving a notification from the SCC AS responsive to the subscription of a change in Inter-UE Transfer (IUT) of media content,
wherein the SCC AS detected the change in IUT of the media content for the collaborative session and further determined that the selected one of the controller UE and the controllee UE did not signal for the change in IUT of the media content.

44. A computer program product for Internet Protocol Multimedia Subsystem (IMS) service continuity in a home network based collaborative session, comprising:
a non-transitory computer-readable medium storing sets of code comprising:
a first set of codes for causing a computer to signal a Session Continuity Controller (SCC) Application Server (AS) for participating in a collaborative session terminating at a remote User Equipment (UE) as a selected one of a controller UE and a controllee UE;
a second set of codes for causing the computer to transmit to the SCC AS a subscription to a dialog event package for the collaborative session; and
a third set of codes for causing the computer to receive a notification from the SCC AS responsive to the subscription of a change in Inter-UE Transfer (IUT) of media content,
wherein the SCC AS detected the change in IUT of the media content for the collaborative session and further determined that the selected one of the controller UE and the controllee UE did not signal for the change in IUT of the media content.

45. An apparatus for Internet Protocol Multimedia Subsystem (IMS) service continuity in a home network based collaborative session, comprising:
means for signaling a Session Continuity Controller (SCC) Application Server (AS) for participating in a collaborative session terminating at a remote User Equipment (UE) as a selected one of a controller UE and a controllee UE;
means for transmitting to the SCC AS a subscription to a dialog event package for the collaborative session; and
means for receiving a notification from the SCC AS responsive to the subscription of a change in Inter-UE Transfer (IUT) of media content,
wherein the SCC AS detected the change in IUT of the media content for the collaborative session and further determined that the selected one of the controller UE and the controllee UE did not signal for the change in IUT of the media content.

46. An apparatus for Internet Protocol Multimedia Subsystem (IMS) service continuity in a home network based collaborative session, comprising:
a transceiver of a selected one of controller User Equipment (UE) and a controllee UE for signaling a Session Continuity Controller (SCC) Application Server (AS) for participating in a collaborative session terminating at a remote User Equipment (UE);
a computing platform via the transceiver for transmitting to the SCC AS a subscription to a dialog event package for the collaborative session; and
the transceiver further for receiving a notification from the SCC AS responsive to the subscription of a change in Inter-UE Transfer (IUT) of media content,
wherein the SCC AS detected the change in IUT of the media content for the collaborative session and further determined that the selected one of the controller UE and the controllee UE did not signal for the change in IUT of the media content.

47. The apparatus of claim 46, wherein the transceiver is further for transmitting to the SCC AS the subscription to the dialog event package for the collaborative session by transmitting an explicit duration value for the subscription.

48. The apparatus of claim 46, wherein the transceiver is further for transmitting the subscription to the dialog event package for the collaborative session by transmitting the subscription to receive information about existing media components.

49. The apparatus of claim 48, wherein the transceiver is further for transmitting the subscription to receive information by transmitting the subscription to receive related information comprising a media property and port numbers in the collaborative session between the controller UE and the remote UE.

50. The apparatus of claim 46, wherein the transceiver is further for transmitting the subscription from the controllee UE to the dialog event package for the collaborative session by transmitting the subscription for information about participation by the controller UE in the collaborative session.

51. The apparatus of claim 50, wherein the transceiver is further for transmitting the subscription for information about participation by the controller UE by transmitting the subscription for information about media components and related information comprising a media property and a port number belonging to the controller UE.

52. The apparatus of claim 46, wherein the transceiver is further for the transmitting from the subscription from the controller UE to the dialog event package for the collaborative session by transmitting the subscription for information about participation by the controllee UE in the collaborative session.

53. The apparatus of claim 52, wherein the transceiver is further for transmitting the subscription for information about participation by the controllee UE by transmitting the subscription for information about media components and related information comprising a media property and a port number belonging to the controllee UE.

54. The apparatus of claim 46, wherein the SCC AS detects the change in IUT of the media content by communicating with the controllee UE to transfer the media content.

55. The apparatus of claim 54, wherein the SCC AS communicates with the controllee UE to transfer the media content by:
signaling the controllee UE for the transfer of medium content to be inactive;
notifying the remote UE and the controller UE of the change in IUT of the media content; and
signaling the controllee UE for the transfer of the medium content to be active.

56. The apparatus of claim 46, wherein the SCC AS detects the change in IUT of media content by:
maintaining respective dialogs with the controller UE, the controllee UE and the remote UE;
receiving a message containing a refer-to heading addressed to the collaborative session;
determining that a media line in the message references media content available from the controllee UE and not the controller UE; and
sending a Session Initiation Protocol (SIP) invite request to the controllee UE to transfer the media content.

57. The apparatus of claim 46, wherein the transceiver is further for receiving the notification from the SCC AS responsive to the subscription of the change in IUT of the media content by receiving a Session Initiation Protocol (SIP) notify request constructed by having an XML body with a session description element containing a Session Description Protocol (SDP) of all of the controllee UEs and remote UEs, including media lines and related information.

58. The apparatus of claim 46, wherein the transceiver is further for receiving a Session Initiation Protocol (SIP) request at the controller UE in response to determining that a change in inter-UE transfer (IUT) of media content requested by an initial SIP refer request by the controller UE has been fulfilled.
